(19) United States
(12) Patent Application Publication
(10) Pub. No.: US 2026/0085216 A1
(43) Pub. Date: Mar. 26, 2026

(54) EMULSION INCLUDING ACRYLIC POLYMER PARTICLES AND RELATED PROCESSES

(71) Applicant: 3M INNOVATIVE PROPERTIES COMPANY, St. Paul, MN (US)

(72) Inventors: Zachary A. Danielson, Maplewood, MN (US); Dillon S. Gentekos, St. Paul, MN (US); Ryan K. McKenney, Roseville, MN (US); Maria O. Miranda, Minneapolis, MN (US); Xuemei Pan, Songjiang District (CN); Christopher C. Pattillo, Maplewood, MN (US); Lili Qie, Woodbury, MN (US); Shupeng Wu, Kushan (CN)

(21) Appl. No.: 19/113,852

(22) PCT Filed: Sep. 21, 2022
(86) PCT No.: PCT/CN2022/120129

§ 371 Date: Mar. 20, 2025

(51) Int. Cl. C09J 133/26; C08F 220/18; C09J 5/00; C09J 133/06

(52) U.S. Cl. CPC C09J 133/26; C08F 220/1808; C09J 5/00; C09J 133/064; C08F 2800/20; C08F 2810/20; C09J 2400/246; C09J 2400/266

(57) ABSTRACT

An emulsion includes water, an emulsifier, and acrylic polymer particles dispersed in the water. The acrylic polymer particles include monomer units of an alkyl acrylate, alkyl methacrylate, or combination thereof, in which alkyl has at least eight carbon atoms; at least one percent by weight acid-functional monomer units, based on the total weight of the monomer units in the acrylic polymer particles; monomer units of a high T_{g} monomer comprising at least one of t-octyl acrylamide, t-butyl methacrylate, t-butyl acrylate, isobornyl acrylate, or isobornyl methacrylate; and a chain terminal group having at least four carbon atoms and a thioether group. In some embodiments, the emulsion provides an adhesive able to hold a pinch bond in a foam cube within one minute of spraying the emulsion. A process for making the composition and a process for making a bonded article using the composition are also described.

### BACKGROUND

Pressure-sensitive adhesives (often referred to as PSAs) are useful for a variety of purposes. Applying PSAs may involve applying an adhesive polymer composition in organic solvent or as an emulsion onto a substrate and subsequently removing the solvent or water. Water-based adhesives have desirable advantages over their traditional solvent borne counterparts in that they can have low or no volatile organic compounds and can be nonflammable.

CN107573453 (published Sep. 19, 2017) discloses an aqueous single-component water-based spray adhesive. WO2020/245690 (published May 21, 2020) and CN113308903 (published May 26, 2021) disclose water-based acrylate adhesive compositions. EP2246403 (published Apr. 16, 2010) discloses a waterborne floor or contact adhesive. JP 2008184494 and JP2008184495 (published Jan. 9, 2007) disclose aqueous dispersions of polymer of particles and related adhesives. U.S. Pat. Appl. Pub. No. 2022/0033692 (Muller et al.) discloses polymer latex compositions and a one-part aqueous contact adhesive comprising such a polymer latex composition. U.S. Pat. No. 5,553,455 (Shah) discloses a waterborne contact adhesive comprising an aqueous emulsion of an emulsified acrylic polymer and a latex of an elastomer, particularly natural rubber latex. U.S. Pat. No. 5,300,554 (Krell et al.) discloses aqueous contact adhesive dispersions containing a copolymer of vinyl esters of aliphatic carboxylic acids having 2 to 12 carbon atoms and acrylic acid esters of aliphatic alcohols having 4 to 12 carbon atoms. U.S. Pat. No. 10,221,343 (Qie et al.) discloses one-part, fast-setting, aqueous adhesive emulsions including a core-shell acrylic polymer. U.S. Pat. No. 11,021,629 (Iyer et al.) discloses two-part aqueous coating compositions in which the first coating component can comprise one or more polymers and the second coating component can comprise a flocculant.

### SUMMARY

The present disclosure provides an emulsion that includes acrylic polymer particles in water. Typically, and advantageously, the emulsion quickly develops adhesive characteristics, for example, within one minute of being sprayed on a substrate.

In one aspect, the present disclosure provides an emulsion that includes water, an emulsifier, and acrylic polymer particles dispersed in the water. The acrylic polymer particles include monomer units of an alkyl acrylate, an alkyl methacrylate, or a combination thereof, in which alkyl has at least eight carbon atoms; at least one percent by weight acid-functional monomer units, based on the total weight of the acrylic polymer particles; monomer units of a high T_{g} monomer comprising at least one of t-octyl acrylamide, t-butyl methacrylate, t-butyl acrylate, isobornyl acrylate, or isobornyl methacrylate; and a chain terminal group having at least four carbon atoms and a thioether group. In some embodiments, the emulsion provides an adhesive able to hold a pinch bond in a foam cube within one minute of spraying the emulsion.

In another aspect, the present disclosure provides a process for making the emulsion described above. The process includes combining components including water; the emulsifier; the alkyl acrylate, the alkyl methacrylate, or the combination thereof, at least one percent by weight of the acid-functional monomer, based on the total weight of monomers; the high T_{g} monomer; a chain transfer agent comprising a mercaptan group; and a polymerization initiator and reacting the alkyl acrylate, the alkyl methacrylate, or the combination thereof, the acid-functional monomer; the high T_{g} monomer, the chain transfer agent, and optionally the emulsifier to provide the emulsion.

In another aspect, the present disclosure provides a process for making a bonded article that includes a first substrate or a second substrate. The process includes spraying the aforementioned emulsion to provide an adhesive on at least one of the first substrate or the second substrate and adhering the first substrate and the second substrate together. In some embodiments, adhering the first substrate and the second substrate is carried out within one minute after spraying.

In this application, terms such as “a”, “an” and “the” are not intended to refer to only a singular entity but include the general class of which a specific example may be used for illustration. The terms “a”, “an”, and “the” are used interchangeably with the term “at least one”. The phrases “at least one of” and “comprises at least one of” followed by a list refers to any one of the items in the list and any combination of two or more items in the list. All numerical ranges are inclusive of their endpoints and non-integral values between the endpoints unless otherwise stated (e.g., 1 to 5 includes 1, 1.5, 2, 2.75, 3, 3.8, 4, and 5, and the like).

The terms “first” and “second” are used in this disclosure in their relative sense only. It will be understood that, unless otherwise noted, those terms are used merely as a matter of convenience in the description of one or more of the embodiments.

As used herein, the term “acrylic” or “acrylate” includes compounds having at least one of acrylic or methacrylic groups.

The term “(meth)acrylate” with respect to a monomer, oligomer or polymer means a vinyl-functional alkyl ester formed as the reaction product of an alcohol with an acrylic or a methacrylic acid.

The term “polymer” or “polymeric” includes homopolymers and copolymers, as well as homopolymers or copolymers that may be formed in a miscible blend, e.g., by coextrusion or by reaction, including, e.g., transesterification. The term “copolymer” includes random, block, graft, and star copolymers.

The term “crosslinking” refers to joining polymer chains together by covalent chemical bonds, usually via crosslinking molecules or groups, to form a network polymer. A crosslinked polymer is generally characterized by insolubility but may be swellable in the presence of an appropriate solvent.

“Alkyl group” and the prefix “alk-” are inclusive of both straight chain and branched chain groups and of cyclic groups. In some embodiments, alkyl groups have up to 30 carbons (in some embodiments, up to 25, 20, 18, 16, or 15 carbons) unless otherwise specified. Cyclic groups can be monocyclic or polycyclic. Alkyl groups are not fluorinated or perfluorinated.

PSAs are well known to those of ordinary skill in the art to possess properties including the following: (1) aggressive and permanent tack, (2) adherence with no more than finger pressure, (3) sufficient ability to hold onto an adherend, and typically, (4) sufficient cohesive strength to be cleanly removable from the adherend. PSAs are tacky and have the ability to adhere without activation by any energy source such as light, heat, or a chemical reaction. Materials that have been found to function well as PSAs are polymers designed and formulated to exhibit the requisite viscoelastic properties resulting in a desired balance of tack, peel adhesion, and shear holding power. One method useful for identifying pressure sensitive adhesives is the Dahlquist criterion. This criterion defines a pressure sensitive adhesive as an adhesive having a creep compliance of greater than 3×10⁻⁶ cm²/dyne as described in Handbook of Pressure Sensitive Adhesive Technology, Donatas Satas (Ed.), 2nd Edition, p. 172, Van Nostrand Reinhold, New York, NY, 1989. Alternatively, since modulus is, to a first approximation, the inverse of creep compliance, pressure sensitive adhesives may be defined as adhesives having a storage modulus of less than about 3×10⁵ N/m².

The above summary of the present disclosure is not intended to describe each disclosed embodiment or every implementation of the present disclosure. The description that follows more particularly exemplifies illustrative embodiments. It is to be understood, therefore, that the drawings and following description are for illustration purposes only and should not be read in a manner that would unduly limit the scope of this disclosure.

### BRIEF DESCRIPTION OF THE DRAWINGS

The disclosure may be more completely understood in consideration of the following detailed description of various embodiments of the disclosure in connection with the accompanying drawings, in which:

FIG. 1a is a perspective view of a foam cube before it is pinched bonded after spraying it with the emulsion of the present disclosure;

FIGS. 1b and 1c are perspective views of a pinch bond being formed in the foam cube of FIG. 1a after it is sprayed with the emulsion of the present disclosure; and

FIG. 1d is a perspective view of the foam cube of FIGS. 1a, 1b, and 1c after it is pinched bonded.

### DETAILED DESCRIPTION

A disadvantage of using water-based adhesives in sprayable applications is that water takes a significantly longer time to evaporate than common organic solvents used in solvent-based adhesives. Water-based adhesives therefore take a long time before they develop PSA characteristics and are tacky enough to bond substrates together (e.g., up to 30 minutes or more in some cases) while organic solvent-based spray adhesives may require just a few seconds or minutes before bonding. Waterborne spray adhesives may also be prone to moisture contamination and thus may not hold well under high temperature or high humidity conditions.

We now describe emulsions and processes that provide water-based adhesives to compete with solvent-based adhesives with regard to the time required to make an adhesive bond. In some embodiments, the emulsion provides an adhesive able to hold a pinch bond in a foam cube within one minute of spraying the emulsion. In some embodiments, the emulsion provides adhesive bonds that are durable even when exposed to high temperature and/or high humidity aging.

Acrylic polymer particles useful in the emulsions and processes of the present disclosure include monomer units of at least one alkyl acrylate, alkyl methacrylate, or combination thereof, in which alkyl has at least 8 carbon atoms. Examples of suitable alkyl (meth)acrylates include those represented by Formula I:

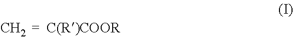

wherein R′ is hydrogen or a methyl group and R is an alkyl group having 8 to 30, 8 to 20, 8 to 18, 8 to 16, or 8 to 12 carbon atoms and may be linear or branched. Examples of suitable monomers represented by Formula I include 2-ethylhexyl acrylate, n-octyl acrylate, 2-octyl acrylate, isooctyl acrylate, n-nonyl acrylate, isononyl acrylate, n-decyl acrylate, isodecyl acrylate, n-dodecyl acrylate, isomyristyl acrylate, n-tridecyl acrylate, n-tetradecyl acrylate, stearyl acrylate, isostearyl acrylate, isobornyl acrylate, octadecyl acrylate, behenyl acrylate, and methacrylates of the foregoing acrylates. Suitable monomer units further include mixtures of at least two or at least three structural isomers of a secondary alkyl (meth)acrylate of Formula II:

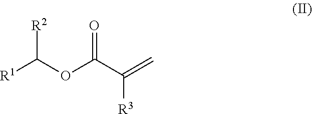

wherein R¹ and R² are each independently a C₁ to C₃₀ saturated linear alkyl group; the sum of the number of carbons in R¹ and R² is 7 to 31; and R³ is H or CH₃. The sum of the number of carbons in R¹ and R² can be, in some embodiments, 7 to 27, 7 to 25, 7 to 21, 7 to 17, 7 to 11, 7, 11 to 27, 11 to 25, 11 to 21, 11 to 17, or 11. Methods for making and using such monomers and monomer mixtures are described in U.S. Pat. No. 9,102,774 (Clapper et al.). Mixtures of one or more monomers of Formula I, Formula II, or combinations of Formulas I and II may be useful for the acrylic polymer particles. In some embodiments, the acrylate, methacrylate, or combination thereof comprises at least one acrylates (as opposed to methacrylate).

In some embodiments, the acrylic polymer particles useful for practicing the present disclosure comprise up to 90 weight percent of monomer units of at least one alkyl acrylate, alkyl methacrylate, or combination thereof, in which alkyl has at least 8 carbon atoms as described above in any of its embodiments. In some embodiments, the acrylic polymer particles useful for practicing the present disclosure comprise at least 40 weight percent of monomer units of at least one alkyl acrylate, alkyl methacrylate, or combination thereof, in which alkyl has at least 8 carbon atoms as described above in any of its embodiments. The weight percent value is based on the total weight of the monomer units in the acrylic polymer particles. In some embodiments, the acrylic polymer particles comprise 40 to 90, 40 to 75, 40 to 60, 45 to 55, 60 to 90 weight percent, 65 to 85 weight percent, or 70 to 80 weight percent of monomer units of at least one alkyl acrylate, alkyl methacrylate, or combination thereof, in which alkyl has at least 8 carbon atoms as described above in any of its embodiments. In the process for making the emulsion, these weight percentages refer to the amount of alkyl acrylate, alkyl methacrylate, or combination thereof, in which alkyl has at least 8 carbon atoms, based upon the total weight of monomers in the combined components.

In some embodiments, the acrylic polymer further comprises monomer units of at least one of a C₁-C₆ alkyl acrylate or C₁-C₆ alkyl methacrylate, in some embodiments, a C₁-C₆ alkyl acrylate. Suitable C₁-C₆ alkyl (meth)acrylates include methyl acrylate, ethyl acrylate, n-propyl acrylate, n-butyl acrylate, hexyl acrylate, cyclohexylacrylate, and combinations thereof. In some embodiments, the C₁-C₆ alkyl acrylate or C₁-C₆ alkyl methacrylate is linear or branched. In some embodiments, the second monomer is methyl acrylate or n-butyl acrylate. In some embodiments, the acrylic polymer particles useful for practicing the present disclosure comprise up to 25 weight percent of monomer units of a C₁-C₆ alkyl acrylate or C₁-C₆ alkyl methacrylate as described above in any of its embodiments. In some embodiments, the acrylic polymer particles useful for practicing the present disclosure comprise at least 5 weight percent of monomer units of a C₁-C₆ alkyl acrylate or C₁-C₆ alkyl methacrylate as described above in any of its embodiments. The weight percent value is based on the total weight of the monomer units in the acrylic polymer particles. In some embodiments, the acrylic polymer particles comprise 5 to 25, 5 to 15, 10 to 25, or 15 to 25 weight percent of monomer units of a C₁-C₆ alkyl acrylate or C₁-C₆ alkyl methacrylate as described above in any of its embodiments. In the process for making the emulsion, these weight percentages refer to the amount of C₁-C₆ alkyl acrylate or C₁-C₆ alkyl methacrylate, based upon the total weight of monomers in the combined components.

At least one percent by weight of monomer units in the acrylic polymer particles useful in the emulsions and processes of the present disclosure include an acid functional group. In some embodiments, the acid-functional monomer comprises a carboxylic acid. Monomers that have carboxylic acid groups include acrylic acid, methacrylic acid, itaconic acid, maleic acid, fumaric acid, ethacrylic acid, crotonic acid, citraconic acid, cinnamic acid, beta-carboxy ethyl acrylate, and 2-methacrylolyloxyethyl succinate. Sulfonic acid- and phosphonic acid-functional monomers such as 2-acrylamido-2-methylpropane sulfonic acid and vinyl phosphonic acid may also be useful. Monomers units including an acid functional group encompasses salts of these acids, such as alkali metal salts and ammonium salts. In some embodiments, the acid-functional monomer units comprise acrylic acid monomer units, methacrylic acid monomer units, or a combination of acrylic acid monomer units and methacrylic acid monomer units. In some embodiments, the acrylic polymer particles comprise up to 5 weight percent or up to 4 weight percent acid-functional monomeric units, based on the total weight of the monomer units in the acrylic polymer particles. In some embodiments, the acrylic polymer particles comprise 1 to 5 weight percent, 1.5 to 5 weight percent, 2 to 5 weight percent, 2 to 4 weight percent, or 2 to 3.8 weight percent acid-functional monomeric units. In the process for making the emulsion, these weight percentages refer to the amount of acid-functional monomer, based upon the total weight of monomers in the combined components.

The acrylic polymer particles useful in the emulsions and processes of the present disclosure further comprise monomer units of a “high T_{g}” monomer that when polymerized provides a homopolymer having a glass transition temperature (T_{g}) of at least 40° C. or at least 50° C. when homopolymerized (i.e., a homopolymer formed from the monomer has a T_{g} at least 40° C. or at least 50° C.). The T_{g} of the homopolymers are measured by Differential Scanning Calorimetry, and many are reported in the Polymer Properties Database found at polymerdatabase.com. The high T_{g} monomers have a single (meth)acryloyl group and comprise at least one of tert-butyl methacrylate, tert-butyl acrylate, isobornyl methacrylate, isobornyl acrylate, t-octyl acrylamide, or t-octyl methacrylamide. Isobornyl acrylate and isobornyl methacylate provide homopolymers having T_{g}s of 97° C. and 110° C., respectively, which is similar to t-butyl methacrylate homopolymer's T_{g} of 118° C. Therefore, it is believed that examples made from isobornyl acrylate and isobornyl methacylate will behave similarly to the examples made from t-butyl methacrylate described below. In some embodiments, the high T_{g} monomer comprises at least one oft-octyl acrylamide, tert-butyl methacrylate, or tert-butyl acrylate. In some embodiments, the high T_{g} monomer comprises at least one of t-octyl acrylamide or t-butyl methacrylate. In some embodiments, the high T_{g} monomer is t-octyl acrylamide. In some embodiments, the high T_{g} monomer is t-butyl methacrylate. Other high T_{g} monomers such as methyl methacrylate, styrene, and vinyl acetate may be avoided in the acrylic polymer particles disclosed herein.

In some embodiments, the acrylic polymer particles useful for practicing the present disclosure comprise 3 to 35 weight percent high T_{g} monomeric units as described above in any of its embodiments, based on the total weight of the monomer units in the acrylic polymer particles. In some embodiments, the acrylic polymer particles useful for practicing the present disclosure comprise 3 to 15, 5 to 10, 20 to 35, or 20 to 30 weight percent monomer units of a high T_{g} monomer as described above in any of its embodiments. In some embodiments, the acrylic polymer particles comprise not more than 1, 0.5, 0.1, 0.05, or 0 monomer units of at least one of methyl methacrylate, styrene, or vinyl acetate. In the process for making the emulsion, these weight percentages refer to the amount of high T_{g} monomer, based upon the total weight of monomers in the combined components.

Acrylic polymer particles useful in the emulsions and processes of the present disclosure include a chain terminal group having at least four carbon atoms and attached to the acrylic polymer through a thioether group. A thioether group is represented by formula —R₂C—S—CR₂—, in which R is hydrogen or alkyl. In some embodiments, the acrylic polymer particles do not contain thiocarbonyl-thio groups (i.e., —C(S)—S—). In some embodiments, the chain terminal group has at least 6 or 8 carbon atoms. In some embodiments, the chain terminal group has up to 30, 24, 20, 18, 16, or 12 carbon atoms. Terminal groups having at least four carbon atoms and attached to the polymer through a thioether group are typically incorporated into the acrylic polymer particles through the use of a mercaptan chain transfer agent during an emulsion polymerization described in further detail below. Examples of useful chain transfer agents having a mercaptan group include alkyl mercaptans having four to 18 carbon atoms and mercaptocarboxylic acid esters. Specific examples of useful chain transfer agents include isooctyl thioglycolate, dodecyl thioglycolate, isooctyl 3-mercaptopropionate, ethyl hexyl thioglycolate, butyl 3-mercaptopropionate, butyl thioglycolate, octyl mercaptan, 1-dodecanethiol, t-dodecyl mercaptan, hexadecyl mercaptan, octadecyl mercaptan, trimethylolpropane-tris-(3-mercaptopropionate), pentaerythritol-tetra-(3-mercaptopropionate), pentaerythritol-tetra-(thioglycolate), pentaerythritol-tetra-(thiolactate), and dipentaerythritol-hexa-(thioglycolate). In some embodiments, the acrylic polymer particles useful for practicing the present disclosure comprise 0.005 to 0.1 weight percent chain terminal groups having at least four carbon atoms and attached to the polymer through a thioether group, based on the total weight of the acrylic polymer particles. In some embodiments, the acrylic polymer particles useful for practicing the present disclosure comprise 0.01 to 0.1, 0.02 to 0.075, 0.025 to 0.06, or 0.03 to 0.04 weight percent chain terminal groups, based on the total weight of the monomer units in the acrylic polymer particles. In the process for making the emulsion, these weight percentages refer to the amount of chain transfer agent, based upon the total weight of monomers in the combined components.

In some embodiments, the acrylic polymer particles are crosslinked. Crosslinked acrylic polymer particles may be made, for example, by including one or more polyfunctional crosslinking monomers in the formulation. In some embodiments, the acrylic polymer particles useful in the emulsions and processes of the present disclosure further comprise monomer units of a multifunctional acrylate or multifunctional methacrylate. Suitable polyfunctional monomers include diacrylate esters of diols, such as ethylene glycol diacrylate, diethylene glycol diacrylate, propanediol diacrylate, butanediol diacrylate, butane-1,3-diyl diacrylate, pentanediol diacrylate, hexanediol diacrylate (including 1,6-hexanediol diacrylate), heptanediol diacrylate, octanediol diacrylate, nonanediol diacrylate, decanediol diacrylate, and dimethacrylates of any of the foregoing diacrylates. Further suitable polyfunctional monomers include polyacrylate esters of polyols, such as glycerol triacrylate, dipropylene glycol diacrylate, tripropylene glycol diacrylate, trimethylolpropane triacrylate, pentaerythritol tetraacrylate, neopentyl glycol diacrylate, dipentaerythritol pentaacrylate, methacrylates of the foregoing acrylates, and combinations thereof. Further suitable polyfunctional crosslinking monomers include divinyl benzene, allyl methacrylate, diallyl maleate, diallyl phthalate, and combinations thereof. Further suitable polyfunctional crosslinking monomers include polyfunctional acrylate oligomers comprising two or more acrylate groups. The polyfunctional acrylate oligomer may be a urethane acrylate oligomer, an epoxy acrylate oligomer, a polyester acrylate, a polyether acrylate, a polyacrylic acrylate, a methacrylate of any of the foregoing acrylates, or a combination thereof. Combinations of any of these crosslinking monomers may be useful. In some embodiments, not more than 1, 0.5, 0.25, 0.1, 0.05, or 0.01 percent by weight of monomer units in the acrylic polymer useful in the compositions and processes of the present disclosure are derived from crosslinking monomers. The acrylic polymer particles may be free of crosslinking monomer units. In some embodiments, the acrylic polymer particles useful for practicing the present disclosure comprise 0 to 0.1 weight percent crosslinking monomer units, based on the total weight of the monomer units in the acrylic polymer particles. In some embodiments, the acrylic polymer particles useful for practicing the present disclosure comprise 0.001 to 0.1 weight percent, 0.005 to 0.05 weight percent, or 0.0075 to 0.025 weight percent crosslinking monomer units. In the process for making the emulsion, these weight percentages refer to the amount of crosslinking monomer, based upon the total weight of monomers in the combined components.

In some embodiments, the acrylic polymer particles useful in the emulsions and processes of the present disclosure further comprise monomer units bearing at least one ketone or aldehyde functional group. In some embodiments, the acrylic polymer particles further comprise monomer units bearing at least one ketone functional group. Examples of monomers that include ketones include diacetone acrylamide, acetoacetoxy ethyl (meth)acrylate, acetoacetoxy butyl (meth)acrylate, acetoacetoxy ethyl (meth)acrylamide, acetoacetamido ethyl (meth)acrylate, vinyl methyl ketone, and allyl acetoacetate. Aldehyde-bearing monomers such as acrolein may also be useful in the acrylic polymer particles. In some embodiments, at least 1, 0.95, 0.75, 0.5, 0.25, 0.1, 0.05, or 0.01 percent by weight of monomer units in the acrylic polymer particles useful in the emulsions and processes of the present disclosure include at least one ketone or aldehyde functional group. In some embodiments, not more than 4, 3, 2.5, 2.0, 1.75, 1.5, or 1.35 percent by weight of monomer units in the acrylic polymer particles useful in the emulsions and processes of the present disclosure include at least one ketone or aldehyde functional group. The acrylic polymer particles may be free of monomer units bearing at least one ketone or aldehyde functional group. In some embodiments, the acrylic polymer particles useful for practicing the present disclosure comprise 0.1 to 5 weight percent monomer units bearing at least one ketone functional group, based on the total weight of the monomer units in the acrylic polymer particles. In some embodiments, the acrylic polymer particles useful for practicing the present disclosure comprise 0.2 to 4 weight percent or 0.5 to 2 weight percent monomer units bearing at least one ketone functional group. In the process for making the emulsion, these weight percentages refer to the amount of monomer bearing at least one ketone or aldehyde functional group, based upon the total weight of monomers in the combined components.

In some embodiments in which the acrylic polymer particles useful for practicing the present disclosure further comprise monomer units bearing at least one ketone functional group, the emulsion of the present disclosure further comprises a polyhydrazide, polyhydrazine, or polyamine (in some embodiments, polyhydrazide) crosslinker. Examples of suitable polyhydride crosslinkers include adipic dihydrazide, oxalic acid dihydrazide, ethylmalonic acid dihydrazide, succinic acid dihydrazide, glutaric acid dihydrazide, tartaric acid dihydrazide, pimelic acid dihydrazide, 9,10-dihydro-9,10-ethanoanthracene-11,12-dicarboxylic acid dihydrazide, valine dihydrazide, orthophthalic acid dihydrazide, isophthalic acid dihydrazide, terephthalic acid dihydrazide, sebacic acid dihydrazide, malonic acid dihydrazide, maleic acid dihydrazide, fumaric acid dihydrazide, and itaconic acid dihydrazide. Examples of suitable polyhydrazine crosslinkers include dihydrazinoalkynones and dihydrazines of aromatic hydrocarbons (e.g., 1,4-dihydrazinebenzene and 2,3-dihydrazinonapththalene). Examples of suitable polyamine crosslinkers include ethylene diamine, propylene diamine, tetramethylenediamine, pentamethylenediamine, hexamethylene diamine, diethylene triamine, and triethylenetetramine. The polyhydrazide, polyhydrazine, or polyamine crosslinker can be added to the emulsion before or after the emulsion polymerization reaction described below. In some embodiments, the polyhydrazide or polyhydrazine crosslinker is added to the emulsion after the polymerization forming the acrylic polymer particles. In some embodiments, the crosslinker is a polyhydrazide. The emulsion may contain the polyhydrazide crosslinker unreacted, or the emulsion may include a keto-polyhydrazide reaction product, which may comprise polyhydrazone linkages. In some embodiments, the amount of polyhydrazide, polyhydrazine, or polyamine (in some embodiments, polyhydrazide) crosslinker in the emulsion is such that there are between 0.5 and 1.5 equivalents of the functional groups from the crosslinker for each equivalent of ketone or aldehyde functional group in the acrylic polymer particles. In some embodiments, the emulsion includes up to 1, 0.5, 0.25, or 0.2 percent by weight and/or at least 0.005, 0.01, 0.05, or 0.1 percent by weight of the polyhydrazide, polyhydrazine, or polyamine (in some embodiments, polyhydrazide) crosslinker, based on the total weight of the emulsion.

Crosslinked acrylic polymer particles may be crosslinked within the particles such as by incorporating polyfunctional crosslinking monomer units as described above, between the particles such as by using polyhydrazide, polyhydrazine, or polyamine (in some embodiments, polyhydrazide) crosslinker to crosslink monomer units including at least one of a ketone or aldehyde functional group, or both crosslinked within the particles and between the particles. Crosslinking within the particles may also occur when the polyfunctional crosslinking monomers are not included in the components to be polymerized. For example, some monomers such as acetoacetoxy ethyl methacrylate monomer may include some diacrylate impurity that can crosslink the acrylic polymer particles. The combination of t-octyl acrylamide and an acid-functional monomer can result in acid-base interactions in the acrylic polymer particles that can effectively cause crosslinking within the particles. Crosslinking either within or between particles may be evidenced by the gel content of the emulsion. In some embodiments, the emulsion has a gel content of at least 28 percent. In some embodiments, when the emulsion includes a polyhydrazide, polyhydrazine, or polyamine (in some embodiments, polyhydrazide) crosslinker, the emulsion has a gel content of at least 60, 70, 80, or 90 percent. In some embodiments, if the acrylic polymer particles are only crosslinked within the particles, the emulsion has a gel content of less than 60, 50, 40, or 30 percent. Gel content is determined by the method provided in the Examples, below.

In some embodiments, the acrylic polymer particles useful for practicing the present disclosure comprise a range from 40 to 90 percent by weight of the monomer units of at least one alkyl acrylate, alkyl methacrylate, or combination thereof, wherein alkyl has at least 8 carbon atoms; a range of 0 to 25 percent by weight of a C₁-C₆ alkyl acrylate; a range of 2 to 5 percent by weight of the acid-functional monomer units; a range of 3 to 15 percent by weight of t-octyl acrylamide; a range from 0 to 5 percent by weight of monomer units bearing at least one ketone or aldehyde functional group, and a range from 0.02 to 0.075 percent by weight of the chain terminal group, based on the total weight of the monomer units in the acrylic polymer particles. In some of these embodiments, the acrylic polymer particles include 1.6 to 2.5 percent by weight of the emulsifier, based on the total weight of the monomer units in the acrylic polymer particles. In some embodiments, the acrylic polymer particles comprise a range from 40 to 90 percent by weight of the monomer units of at least one alkyl acrylate, alkyl methacrylate, or combination thereof, wherein alkyl has at least 8 carbon atoms; a range of 0 to 25 percent by weight of a C₁-C₆ alkyl acrylate; a range of 2 to 5 percent by weight of the acid-functional monomer units; a range of 10 to 30 percent by weight of t-butyl methacrylate; a range from 0 to 5 percent by weight of monomer units bearing at least one ketone or aldehyde functional group, and a range from 0.02 to 0.075 percent by weight of the chain terminal group, based on the total weight of the monomer units in the acrylic polymer particles.

In some embodiments, the monomer units of at least one alkyl acrylate, alkyl methacrylate, or combination thereof, wherein alkyl has at least eight carbon atoms, the acid-functional monomer units, the monomer units of a high T_{g} monomer, the optional monomer units of at least one of a C₁-C₆ alkyl acrylate or C₁-C₆ alkyl methacrylate, the optional monomer units bearing at least one ketone or aldehyde functional group, and the optional polyfunctional crosslinking monomers as described above in any of their embodiments make up at least 95, 96, 97, 98, 99, 99.5, 99.6, 99.7, 99.8, 99.9, or 100 percent of the monomer units, based on the total weight of the monomer units in the acrylic polymer particles. The acrylic polymer particles may be free of or include less than 0.1, 0.5, or 1 percent of at least one N-methylolacrylamide, styrene, methyl methacrylate, a vinyl ester, vinyl acetate, quaternary amino-functional (meth)acrylate, epoxy-functional (meth)acrylate, or a silane-functional (meth)acrylate, based on the total weight of the monomer units in the acrylic polymer particles.

In some embodiments, the acrylic polymer particles in the emulsion of the present disclosure and/or made by the process of the present disclosure is not a core-shell polymer having different monomer compositions in the core and the shell. When referring to a core-shell polymer, the core typically makes up about 25 weight percent (wt. %) of the core-shell polymer and can comprise up to 83 wt. % of the core-shell polymer. In this way, a core-shell polymer is different from a polymer particle made by a seed polymerization, in which the seed composition typically provides up to 10 wt. % or up to 5 wt. % of the polymer particle. While polymerizations result in a distribution of compositions and molecular weights, the emulsion polymerization is, in some embodiments, not carried out so that the monomer composition is changed during the polymerization to provide polymer particles with cores having a different glass transition temperature or a different reactivity from the shell. In some embodiments, the acrylic polymer particles include a random co-polymer the monomer units of at least one alkyl acrylate, alkyl methacrylate, or combination thereof, wherein alkyl has at least eight carbon atoms, the acid-functional monomer units, the monomer units of a high T_{g} monomer, the optional monomer units of at least one of a C₁-C₆ alkyl acrylate or C₁-C₆ alkyl methacrylate, the optional monomer units bearing at least one ketone or aldehyde functional group, and the optional polyfunctional crosslinking monomers.

In some embodiments, the acrylic polymer particles make up at least 70, 80, 95, or 99 wt. % of the polymers in the emulsion. The emulsion contains, in some embodiments, not more than 30, 20, 10, 5, or 1 wt. % of polymers such as polychloroprene, natural rubber, synthetic polyisoprene, or polyvinyl alcohol. Depending on the amount of any of the additives described below, in some embodiments, emulsion may include at least 70, 75, 80, 90, 95, 98, or 99 weight percent of the acrylic polymer particles described above in any of their embodiments, based on the total amount of solids in the composition (that is, excluding water).

The acrylic polymer useful in the emulsion and processes of the present disclosure is conveniently prepared by emulsion polymerization. An acrylic monomer or combination of monomers as described above in any of their embodiments is combined with water and an emulsifier or combination of emulsifiers and then the monomer or monomers are polymerized. One or more of the monomers can be emulsified first in the stirred aqueous phase before initiation is begun. The many parameters of emulsion polymerization technique can be adjusted by those skilled in the art. For example, initiator can be added according to a variety of possible schedules, and monomers can be added continuously or in staggered increments. Additionally, a polymerization can be started in the presence of a previously prepared seed.

An emulsifier is present in the emulsion of the present disclosure and in the components combined in the process for making the adhesive composition of the present disclosure. In some embodiments, the emulsifier is an anionic surfactant. Useful anionic surfactants include those that include at least one hydrophobic moiety such as an about 6 carbon atom- to about 12 carbon atom-alkyl, alkylaryl, and/or alkenyl group as well as at least one anionic group selected from carboxylate, sulfate, sulfonate, phosphate, polyoxyethylene sulfate, polyoxyethylene sulfonate, polyoxyethylene phosphate, and/or salts of such anionic groups such as alkali metal salts (e.g., sodium, potassium) and ammonium salts. Any fatty acid soap (e.g., alkyl succinates), ethoxylated fatty acids, and/or the alkali metal salts ammonium salts thereof, dialkylsulfosuccinates, and sulfated oils may be useful. Some useful anionic surfactants include sodium lauryl sulfate, sodium lauryl ether sulfate, sodium dodecylbenzene sulfonate and sulfosuccinate esters. Representative commercial examples of anionic surfactants include sodium lauryl sulfate, available from Stepan Chemical Co. under the trade designation “POLYSTEP B-3”; sodium lauryl ether sulfate, available from Stepan Chemical Co. under the trade designation “POLYSTEP B-12”; and sodium dodecylbenzenesulfonate, available from Rhodia, Incorporated under the trade designation “RHODACAL DS-10”. Combinations of any of these surfactants may be useful.

In some embodiments, the emulsifier is copolymerizable with the monomer or monomer mixture and becomes incorporated into the acrylic polymer. The copolymerizable emulsifier has at least one group, or only one group, capable of reacting with the monomer or monomer mixture. Such reactive groups include ethylenically unsaturated groups such as vinyl groups and acrylate groups. Examples of polymerizable emulsifiers include sodium styrene sulfonate (commercially available from Alfa Aesar and Tosoh), sodium vinylsulfonate, polysodium styrene sulfonate, polyoxyethylene alkylphenyl ether ammonium sulfates those obtained under the trade designation “HITENOL BC” from Dai Ichi Kogyo Seiyaku, Kyoto, Japan, including polyoxyethylene nonylpropenyl phenyl ether ammonium sulfate, polyoxyethylene styrenated phenyl ether ammonium sulfates such as those obtained under the trade designation “HITENOL AR” from Dai Ichi Kogyo Seiyaku, and polyoxyethylene alkylether sulfuric esters such as those obtained under the trade designation “HITENOL KH” from Dai Ichi Kogyo Seiyaku.

The total amount of surfactant used in the preparation of the emulsion is typically 5, 3, 2, 1.75, 1.5, or 1.3 wt. % or less, based on the weight of the acrylic polymer particles. In some embodiments, the total amount of emulsifier employed is anionic in nature.

In some embodiments a small amount (e.g., less than 5 wt. % of the total surfactant amount) of nonionic surfactant may be employed if desired. A variety of surfactants known to those skilled in the art may be useful. Representative commercial examples of nonionic surfactants include “TRITON CG 600” (a polyalkyl glucoside) available from Dow Chemical Company, polyoxoethylene alkyl ethers such as “LUTENSOL” available from BASF, ethylene oxide-propylene oxide copolymers available under the trade designation “MAKON” available from Stepan, and polymerizable surfactants including polyoxyethylene alkylphenyl ethers such as those obtained under the trade designation “NOIGEN RN” from Montello, Inc.

Emulsion polymerization is carried out in water. The water is present in the emulsion of the present disclosure. The amount of water in the emulsion of the present disclosure and/or made by the process of the present disclosure is typically at least 25% by weight or 30% by weight, based on the total weight of the emulsion. The amount of water in the emulsion can be up to 65%, 60%, 55%, 50%, 45%, or 40% by weight, based on the total weight of the emulsion. Useful amount of water in the emulsion can be in a range from 25% to 65% by weight, 35% to 60% by weight, or 45% to 55% by weight, based on the total weight of the emulsion.

Polymerizing at least one alkyl acrylate, alkyl methacrylate, or combination thereof, wherein alkyl has at least eight carbon atoms, the acid-functional monomer, the high T_{g} monomer, the optional C₁-C₆ alkyl acrylate or C₁-C₆ alkyl methacrylate, the optional monomer bearing at least one ketone or aldehyde functional group, and the optional polyfunctional crosslinking monomer to form the acrylic polymer particles described above in any of their embodiments typically involves a polymerization initiator. Polymerization initiators suitable for preparing the acrylate polymer particles useful in the present disclosure include initiators that, on exposure to heat, generate free-radicals, which initiate polymerization of the monomer or monomer mixture. Water-soluble initiators are useful for preparing the acrylate polymer particles by emulsion polymerization. Suitable water-soluble initiators include potassium persulfate, ammonium persulfate, sodium persulfate, and mixtures thereof, oxidation-reduction initiators such as the reaction product of the above-mentioned persulfates and reducing agents such as those selected from the group metabisulfites, formaldehyde sulfoxylate, 4,4′-azobis(4-cyanopentanoic acid) and its soluble salts (e.g., sodium, potassium), and advanced sulfinic acid derivatives such as those obtained under the trade designations “BRUGGOLITE FF6 M” and “BRUGGOLITE TP1651” from L. Brueggemann GMBH & Co. KG., Heilbronn, Germany. When used, initiators may comprise from about 0.01 to about 1 part by weight, 0.05 to about 1 part by weight, or about 0.1 to about 0.5 part by weight based on 100 parts by weight of monomers. A final oxidation/reducing initiator pair can be added at the end of the reaction to increase conversion. In some embodiments of the process of making an adhesive according to the present disclosure, the polymerization initiator is a water-soluble initiator (e.g., a water-soluble free-radical initiator) or a water-soluble initiator combination including an oxidizing agent and reducing agent.

Catalysts may be useful to accelerate free radical generation. Examples of suitable catalysts include ferrous sulfate and ethylene diamine tetra-acetic acid (EDTA).

Emulsion polymerization can be carried out at a wide variety of temperatures. The temperature can be selected readily by a person skilled in the art and can depend at least in part on the initiator used. In some embodiments, the polymerization is carried out at a temperature in a range from 10° C. to 100° C., in a range from 30° C. to 90° C., in a range from 40° C. to 80° C., or in a range from 65° C. to 75° C. In some embodiments, the polymerization is carried out at a temperature of not more than 70° C., in some embodiments, in a range from 30° C. to 70° C., in a range from 40° C. to 70° C., or in a range from 65° C. to 70° C.

In addition to the combination of monomers as described above in any of their embodiments, water, emulsifier, initiator, chain transfer agent, and optionally the catalyst, the following additives may also optionally be included in the emulsion compositions useful for practicing the present disclosure: inhibitors such as hydroquinone, pigments, dyes, rheology modifiers, thickeners, tackifiers, plasticizers, antioxidants (e.g., hindered phenols, amines, and sulfur and phosphorous hydroperoxide decomposers), stabilizers (e.g., ultraviolet absorbers, hindered amine light stabilizers, and heat stabilizers), fillers (e.g., inorganic fillers such as talc, zinc oxide, titanium dioxide, aluminum oxide), preservatives, biocides, corrosion inhibitors, fire retardants, and defoamers. These additives, if used, are present in conventional concentrations known to those skilled in the art and to the extent they do not unacceptably affect the advantages provided by the present disclosure.

The acrylic polymer particles useful in the emulsions and processes of the present disclosure have a size in a range from 50 nanometers (nm) to 10 micrometers, from 50 nm to 5 micrometers, from 50 nm to 200 nm, from 50 nm to 125 nm, from 50 nm to 100 nm, or from 200 nanometers to 500 nanometers as determined by dynamic light scattering measurements, which is a technique well-known to a person skilled in the art of emulsion polymerization. In some embodiments, the particle size is 500 nm or less, 400 nm or less, 300 nm or less, 200 nm or less, 125 nm or less, or 100 nm or less. In some embodiments, the particle size is at least 50 nm, at least 100 nm, or at least 130 nm. In some embodiments, a particle size of 125 nm, 100 nm, or less can be achieved by using a relatively larger amount of emulsifier (e.g., at more than 5 wt. % or up to or at least 10 wt. %, based on the total weight of the acrylic polymer particles) to make a seed followed by polymerization of the remaining monomers using the amount of surfactant described above.

Upon completion of the emulsion polymerization, the emulsion of the present disclosure and/or prepared by the process of the present disclosure is typically acidic as determined using a standard pH meter or pH paper as is known to those skilled in the art. In some embodiments, the pH of the emulsion is about 3, about 4, or in a range from 3 to 4. In some embodiments of the emulsion and process of the present disclosure, the emulsion further comprises base, for example, to raise the pH. In some embodiments, the pH is raised to at least 3.5, 4, 5, or 6. In some embodiments, the pH is not more than 7. Examples of suitable bases include ammonia (e.g., aqueous ammonia or ammonium hydroxide), mono-, di-, and triethanolamine, sodium hydroxide, triethylamine, monosodium phosphate, ammonium phosphate, and sodium carbonate.

In some embodiments, the emulsion of the present disclosure and/or made by the process of the present disclosure exhibit a viscosity of 12,000 centipoise (12,000 mPa-s) or less as determined using a Brookfield Viscometer, spindle RV 6, at 20 rpm. In some embodiments, the viscosity of the emulsion is not more than 10,000 centipoise (10,000 mPa-s), 7500 centipoise (75000 mPa-s), 5000 centipoise (5000 mPa-s), 3000 centipoise (3000 mPa-s), or 1000 centipoise (1000 mPa-s). In some embodiments, the emulsions have a viscosity of at least 50 centipoise (500 m Pa-s), at least 100 centipoise (100 m Pa-s), at least 300 centipoise (300 m Pa-s), or up to or at least 500 centipoise (500 m Pa-s) as determined using a Brookfield Viscometer, spindle LV 2, at 50 rpm.

In some embodiments, the emulsion of the present disclosure and/or made by the process disclosed herein is substantially free of organic solvents. Common organic solvents include any of those have a boiling point of up to 150° C. at atmospheric pressure. The term “substantially free” means that emulsion can include up to 0.1, 0.05, or 0.01 percent by weight of any of these solvents or can be free of any of these solvents. These percentages are based on the total weight of the acrylic polymer particles. In some embodiments, the emulsion comprises less than 0.1, 0.05, or 0.01 percent by weight of an organic solvent, based on the total weight of the acrylic polymer particles. Some specific examples of organic solvents substantially absent from the emulsion include those having a solubility parameter of about 9 (e.g., in a range from 8.5 to 9.5) such as cyclohexane (8.59), isobutyl acetate (9.10), and hexyl acetate (9.15). In some embodiments, the emulsion is substantially free of one or more of cyclohexane, n-heptane, ethyl acetate, n-butyl acetate, isobutyl acetate, and n-hexyl acetate.

Upon spraying, the emulsion of the present disclosure and/or made by the process of the present disclosure provides an adhesive able to hold a pinch bond in a foam cube within one minute of spraying the emulsion. Pinch bond times are indicative of the relative rate of handling strength buildup. That is, the lower the “pinch bond” time the more quickly the bond has developed handling strength. This provides a measure of how long it takes to form an article which may be handled for further processing.

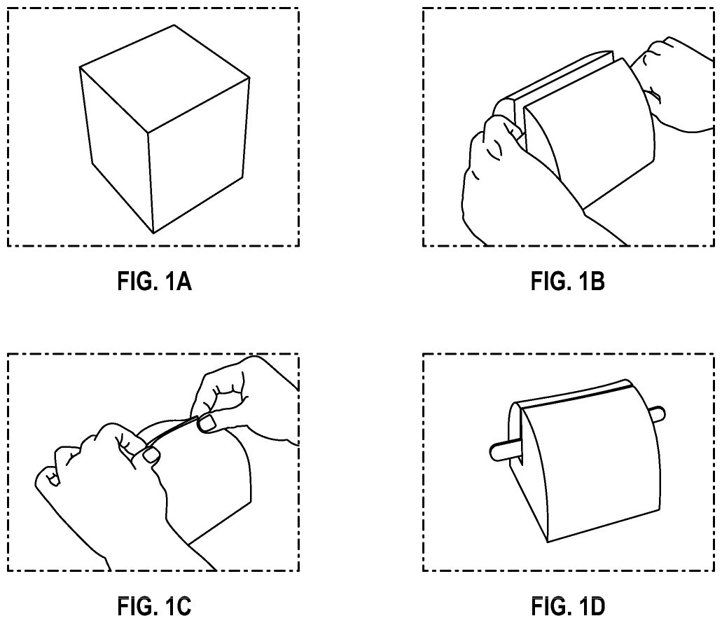

The method forming a pinch bond in a foam cube is described in full detail in the Examples, below, and shown in FIG. 1a to Id. For the purposes of the present disclosure, evaluating the ability of the adhesive to hold a pinch bond in a foam cube, the foam cube is a polyurethane cube with a side dimension of 4 inches (10.2 cm) and a density of at least 1.45 pounds/square foot (lbs./ft.³) (7.08 kilograms/square meter (kg/m²). The amount of emulsion sprayed on one face of the foam cube is in a range from 1 gram to 2 grams. In some embodiments, the emulsion of the present disclosure provides an adhesive able to hold a pinch bond in a foam cube within 45, 30, or 20 seconds. To “hold” a pinch bond, the pinch bond stays intact for at least 24 hours, without the opposing edges of the pinch bonded face coming apart. Generally, it is more difficult for an adhesive to hold a pinch bond in a higher density foam. Accordingly, if an adhesive holds a pinch bond in a relatively higher density foam, it is believed that it will hold a pinch bond in a lower density foam.

Examples 1 to 17, below, demonstrate that emulsions of the present disclosure including acrylic polymer particles having monomer units of at least one alkyl acrylate, alkyl methacrylate, or combination thereof, wherein alkyl has at least eight carbon atoms, acid-functional monomer units, monomer units of a high T_{g} monomer, a chain terminal group having at least four carbon atoms and a thioether group, optionally monomer units of at least one of a C₁-C₆ alkyl acrylate or C₁-C₆ alkyl methacrylate, optionally monomer units bearing at least one ketone or aldehyde functional group, and optionally polyfunctional crosslinking monomers can provide an adhesive that can hold a pinch bond in a foam cube within one minute, 45 seconds, 30 seconds, or even 20 seconds of spraying the emulsion. The emulsions of the present disclosure performed comparably in this evaluation to a polychloroprene Aqueous Contact Adhesive, obtained under the trade designation “FASTBOND 100”, from 3M Company, St. Paul, MN. Furthermore, emulsions of the present disclosure can provide an adhesive that can hold a pinch bond in a foam cube within one minute while some emulsions containing core-shell acrylic polymer particles including methyl methacrylate as a high T_{g} monomer cannot meet this limitation, as reported in U.S. Pat. No. 10,221,343 (Qie et al.). It is unexpected in view of U.S. Pat. No. 10,221,343 (Qie et al.) that emulsions of the present disclosure can provide an adhesive that can hold a pinch bond in a foam cube within one minute even in the absence of keto-polyhydrazide crosslinking as described above.

Factors that can affect the ability of an emulsion to be able to hold a pinch bond in a foam cube within one minute of spraying the emulsion include the pH of the emulsion. In general, with an increase in pH, emulsions including acrylic polymer particles are more stable and less likely upon spraying to provide an adhesive able to hold a pinch bond in a foam cube within one minute, for example. However, the pH at which the emulsions are stable can depend on the specific composition of the acrylic polymer particles, the amount of emulsifier, other additives to the emulsion, and the type of spray system used. For example, the inclusion of methacrylic acid monomer units or C₁-C₆ or C₁-C₄ acrylate monomer units in the acrylic polymer particles may provide a less stable emulsion at a pH of 4 to 7 than an emulsion of acrylic polymer particles in which these monomer units are absent. As shown in Example 14, an emulsion having a pH of 5 can provide an adhesive able to hold a pinch bond in a foam cube within one minute of spraying. In some embodiments, the pH is of the emulsion is in a range from 3 to 5, 3 to 6, or 3 to 7. However, since the pH at which an emulsion is stable can depend on many factors, it is not practical to define the pH for every situation.

We have found that crosslinking within or between the acrylic polymer particles can be useful in providing an adhesive able to hold a pinch bond in a foam cube within one minute of spraying. Crosslinking can be induced by variety of different mechanisms as described above. As shown in Example 1 below, an emulsion including acrylic polymer particles including t-octyl acrylamide and an acid functional monomer provide an adhesive that can hold a pinch bond within 30 seconds of spraying. In some embodiments, the acrylic polymer particles comprise monomer units of an acrylate or methacrylate having more than one acrylate or methacrylate group. We have found that when making the emulsion of the present disclosure a ratio of the chain transfer agent to the acrylate or methacrylate having more than one acrylate or methacrylate group of at least 1:1 can be useful for providing an adhesive that is capable of holding a pinch bond, and a ratio of at least 2:1, at least 3:1, or at least 4:1 may be useful. In embodiments in which the high T_{g} monomer is t-octyl acrylamide, this ratio is greater than 1:1 and is more than 2:1 or at least 3:1 or 4:1 in some embodiments. As shown in Illustrative Examples A to C, when the ratio of chain transfer agent to hexanediol diacrylate crosslinker is 1.8:1, 2:1, or 1:1, respectively, the emulsion requires an open time of five minutes before it can hold a pinch bond in a foam cube. It is believed that the higher crosslinking within the particles of these emulsions can lead to lower tackiness. Illustrative Example D shows that when a ratio of chain transfer agent to hexanediol diacrylate crosslinker of 2:1 is used in acrylic polymer particles having t-butyl methacrylate as a high T_{g} monomer, the emulsion cannot hold a pinch bond in a foam cube within one minute of being sprayed. However, when the formulation is the same except the ratio of chain transfer agent to hexanediol diacrylate is 1:1, the emulsion of Example 7 provides an adhesive that can hold a pinch bond within 20 seconds. In some embodiments, when the high T_{g} monomer is t-butyl methacrylate, a ratio of the chain transfer agent to the acrylate or methacrylate having more than one acrylate or methacrylate group is not more than 2:1 and may be 1:1. It is difficult for a person skilled in the art to be able to analyze crosslinked polymer particles to determine the ratio of chain transfer agent to crosslinking monomer used to make the emulsion of acrylic polymer particles, particularly in embodiments in which there is crosslinking between particles also. The pinch bond evaluation clearly described herein is therefore useful to assess whether an appropriate amount of chain transfer agent and crosslinker are present in the acrylic polymer particles to provide an adhesive. The composition of the acrylic polymer particles cannot otherwise be defined more precisely without unduly restricting its scope.

We have found that when the amount of chain-transfer agent is too high (e.g., 0.2 percent by weight as in WO2020/245690 (published May 21, 2020), the emulsion in the absence of solvent may not provide an adhesive that is able to hold a pinch bond in a foam cube within one minute of spraying even when the acrylic polymer particles are crosslinked by the keto-polyhydrazide reaction as described above. However, as we have found that the particular amount of chain transfer agent useful for making the acrylic polymer particles depends on the particular monomer units in the acrylic polymer particles, it is impractical to recite the exact level of chain transfer agent useful to make the emulsion of the present disclosure.

In some embodiments, the emulsion of the present disclosure provides an adhesive able to hold a pinch bond in a foam cube within one minute of spraying the emulsion even after it is exposed to high temperature and high humidity conditions, which may be useful for some applications. As shown in Examples 3 to 10 and 12 to 16, the emulsions of the present disclosure that include crosslinking within the acrylic polymer particles using any of the mechanisms described above and between the acrylic polymer particles using the keto-polyhydrazide reaction, can provide foam bonding that withstands temperatures of up to 90° C. for up to 48 hours and high temperature along with 85-90% relative humidity for up to 200 hours. Further, as evidenced by a comparison of Example 8 and Example 12, in view of Illustrative Example D, when an emulsion can provide an adhesive able to hold a pinch bond as described herein even in the absence of keto-polyhydrazide crosslinking, adding a polyhydrazide crosslinker to such emulsions can result in the high temperature and high humidity stability of the resulting adhesive being unexpectedly high.

In some embodiments of the emulsion according to the present disclosure and/or the process of making or using the emulsion or adhesive composition of the present disclosure, the emulsion or adhesive composition is substantially free of thermoplastic microspheres containing a blowing agent such as thermoplastic microspheres obtained from Akzo Nobel under the trade designation “EXPANCEL”. “Substantially free” of thermoplastic microspheres containing a blowing agent refers to less than 0.1, or up to 0.099, 0.075, 0.05, 0.01, or 0.005 percent by weight, based on the total weight of the emulsion. The microspheres expand when the temperature is raised and are said to coagulate aqueous polymer dispersions in U.S. Pat. No. 9,624,408 (Pietsch et al.) and 10,662,263 (Schmidt et al.). Advantageously, the emulsions of the present disclosure do not require the addition of thermoplastic microspheres containing a blowing agent (with the concomitant increase in cost) or the application of heat to from an adhesive bond.

The emulsion according to the present disclosure and/or made by the process of the present disclosure typically and advantageously does not require an external coagulant, such as citric acid, lactic acid, acetic acid, or zinc sulfate. Thus, the process of making a bonded article comprising a first substrate and a second substrate does not require spraying a second part including such a coagulant in a predetermined ratio with the emulsion of the present disclosure. Thus, the emulsions and processes of the present disclosure avoid disadvantages associated with a two-part system, for example, the co-spraying equipment being expensive and requiring maintenance and the complexity of monitoring the ratio of the two parts (i.e., the coagulant and the adhesive composition).

In some embodiments, the emulsion of the present disclosure and/or made by the process of the present disclosure is packaged in a spray container. Any of a variety of different spray containers may be useful for delivering the emulsion of the present disclosure and may be useful in the process of making a bonded article according to the present disclosure. Suitable spray-coating equipment includes manual spray operators and automated spray operators. Suitable manual spray operators include the BINKS 2001 SS (available from Binks), BINKS HVLP MACH 1 (available from Binks), DEVILBISS MSA-503 (available from DeVilbiss), GRAYCO 800N (available from Grayco), and HVLP GRAYCO OPTIMIZER (available from Grayco). Suitable automated spray operators include the BINKS 61 (available from Binks), DEVILBISS AGX-4303 (available from DeVilbiss), GRAYCO A800N (available from Grayco), and BINKS HVLPP MACH 1 (available from Binks).

For spraying the emulsion of the present disclosure, an air-assisted spray system may be useful. Examples of useful air-assisted spray systems include those obtained under the trade designation “3M Accuspray ONE Spray Gun System with Standard PPS” and “3M Accuspray Paint Spray System with PPS 2.0” from 3M Company, St. Paul, Minnesota. Thus, the spray container useful for the emulsion of the present disclosure may be a disposable cup or cup and disposable liner attached to a spray gun with an atomizing head or nozzle. Spray can be assisted using compressed air, for example, at pressures in a range from 0.13 Megapascals (MPa) to 0.21 MPa.

An airless spray system may also be useful for spraying the emulsion of the present disclosure. Pressure pots such as one-liter capacity pots with pressure rating up to 225 psi (1.24 MPa), obtained, for example, from Apache Stainless Steel Equipment Corporation, Beaver Dam, Wisconsin can be connected to a nylon hose obtained, for example, under the trade designation “3M Cylinder Adhesive Hose” from 3M Company, St. Paul, Minnesota. The hose can be, for example, up to 8, 7, 6, 5, 4, 3, 2, or 1 meter long. A high throughput metallic spray gun obtained, for example, under the trade designations “GunJet” and “H GunJet” from Spray Systems Co., Minnetonka, Minnesota with a brass spray nozzle obtained, for example, under the trade designations “4001 UniJet”, “6501 UniJet”, “9501 UniJet”, “1100050 UniJet”, and “800050 UniJet” from Spray Systems Co. may conveniently attached to the hose. The canister can be pressurized with dry nitrogen gas or any desirable gas.

Aerosol cans may also be useful for spraying the emulsion of the present disclosure. Aerosol cans can be obtained from a variety of sources, for example, from Ball Metalpack, Broomfield, Colorado, under the trade designation “Classic Tinplate Can”. Any aerosol actuator, for example, that obtained under the trade designation “Seaquist 802-24-20/0890-20FS” from Aptar, Mukwonago, Wisconsin with Buna valves obtained under the trade designation “AR-83” from Aptar, may be useful. Aerosols typically include a propellant. Examples of suitable propellants include nitrogen, carbon dioxide, ethane, propane, isobutane, normal butane, dimethyl ether, 1,1-difluoroethane, trans-1,3,3,3-tetrafluoropropene, and mixtures thereof. Typically, liquid aerosol propellants such as propane, butane, and isobutane are added to the emulsion in an amount ranging from about 5% to about 45% by weight, based on the total weight of the composition. When gases such as nitrogen and carbon dioxide are used as the propellant, the gas propellant is typically present in an amount ranging up to about 10%, 8%, 6%, 5%, or 2% by weight, based on the total weight of the composition.

The present disclosure provides an article that comprises a first substrate and a second substrate bonded together with a composition of the present disclosure and a process for making such an article. The surfaces of the first substrate and the second substrate may be any desired material. In some embodiments, at least one of the surfaces of the first substrate or the surface of the second substrate comprises at least one of metal, glass, a polymer, paper, a painted surface, a nonwoven or woven fabric, wood, foam, or a composite. The material of the surface of the first and second substrate may be found throughout the substrate, or the surface may include a different material from the bulk of the substrate. In some embodiments, the surface of the first substrate and/or second substrate comprises at least one of metal (e.g., steel, stainless steel, or aluminum), glass (e.g., which may be coated with indium tin oxide, for example,), a polymer (e.g., a plastic, rubber, thermoplastic elastomer, or thermoset), paper, a painted surface, or a composite. A composite material may be made from any two or more constituent materials with different physical or chemical properties. When the constituents are combined to make a composite, a material having characteristics different from the individual components is typically achieved. Some examples of useful composites include fiber-reinforced polymers (e.g., carbon fiber reinforced epoxies and glass-reinforced plastic); metal matrix compositions, and ceramic matrix composites. The surface of at least one of the first or second substrates may include polymers such as polyolefins (e.g., polypropylene, polyethylene, high density polyethylene, blends of polypropylene), polyamide 6 (PA6), acrylonitrile butadiene styrene (ABS), polycarbonate (PC), PC/ABS blends, polyvinyl chloride (PVC), polyamide (PA), polyurethane (PUR), thermoplastic elastomers (TPE), polyoxymethylene (POM), polystyrene, polyester (e.g., polyethylene terephthalate), poly(methyl) methacrylate (PMMA), and combinations thereof. The surface of at least one of the first or second substrate may also include a metal coating on such polymers. In some embodiments, at least one of the first or second substrate comprises a transparent material such as glass or a polymer (e.g., acrylic or polycarbonate).

In some embodiments of the bonded article or the process for making the bonded article, at least one of the first or second substrate is a foam. The emulsion of the present disclosure can be useful for adhering a variety of foams including open cell foams and closed cell foams. The foam can be made from a variety of materials, for example, polyurethane (e.g., polyether polyurethane and polyester polyurethane), EPDM, nitrile, PVC, polyethylene, polypropylene, polystyrene, ethylene-vinyl acetate (EVA), neoprene, and styrene-butadiene rubber. The foam can have a variety of densities including a range from 0.4 pounds/square foot (lbs./ft.³) to 10 lbs./ft.³ (1.95 kilograms per square meter (kg/m²) to 48.8 kg/m²). In some embodiments, the foam is a polyurethane open cell foam having a density in a range from 0.4 pounds/square foot (lbs./ft.³) to 5 lbs./ft.³ (1.95 kilograms per square meter (kg/m²) to 24.4 kg/m²). In some embodiments, the foam is a polyethylene closed cell foam having a density in a range from 1 pound/square foot (lbs./ft.³) to 10 lbs./ft.³ (4.88 kilograms per square meter (kg/m²) to 48.8 kg/m²). Foams can be useful for a variety of products including furniture and upholstery, insulation and soundproofing, and protective packaging.

In some embodiments, at least one of the first substrate or second substrate is a fabric (e.g., woven or nonwoven fabric). The term “nonwoven” refers to a material having a structure of individual fibers or threads that are interlaid but not in an identifiable manner such as in a knitted fabric. Examples of nonwoven webs include spunbond webs, spunlaced webs, needle-punched webs, airlaid webs, meltblown web, and bonded carded webs. Useful nonwovens may be made of natural fibers (e.g., wood or cotton fibers), synthetic fibers (e.g., thermoplastic fibers), or a combination of natural and synthetic fibers. Examples of suitable materials for forming thermoplastic fibers include polyolefins (e.g., polyethylene, polypropylene, polybutylene, ethylene copolymers, propylene copolymers, butylene copolymers, and copolymers and blends of these polymers), polyesters, and polyamides. The fibers may also be multi-component fibers, for example, having a core of one thermoplastic material and a sheath of another thermoplastic material. Examples of woven fabrics include twill and canvas.

In some embodiments, at least one of the first substrate or the second substrate is a low surface energy substrate. The term “low surface energy substrate” is meant to refer to those substrates having a surface energy of less than 34 dynes per centimeter. Included among such materials are polypropylene, polyethylene [e.g., high density polyethylene (HDPE), low density polyethylene (LDPE), and liner low density polyethylene (LLDPE)], and blends of polypropylene (e.g., PP/EPDM, TPO). In some embodiments, at least one of the first substrate or the second substrate is a medium surface energy substrate. The term “medium surface energy substrates” is meant to refer to those substrates having a surface energy in a range from 34 to 70 dynes per centimeter, typically from 34 to 60 dynes per centimeter, and more typically from 34 to 50 dynes per centimeter. Included among such materials are polyamide 6 (PA6), acrylonitrile butadiene styrene (ABS), polycarbonate (PC)/ABS blends, PC, PVC, polyamide (PA), polyurethane (PUR), thermoplastic elastomers (TPE), polyoxymethylene (POM), polystyrene, and poly(methyl methacrylate) (PMMA). The surface energy is typically determined from contact angle measurements as described for example in ASTM D7490-08.

The emulsion of the present disclosure and/or made by the process of the present disclosure can be useful in a variety of applications. For example, the emulsion can be useful for bonding geotextiles. Geotextiles are typically made from nonwoven or woven fabric and may be made from low surface energy materials such as polyolefins. Examples of materials useful as geotextiles include polypropylene and polyethylene terephthalate (PET). The emulsion can also be useful for graphics attachment (e.g., branding or information graphics) and plastic assembly. Examples of useful substrate surfaces for graphics attachment include polypropylene, ABS, PC, aluminum, steel, and painted surfaces. Graphic films can be made, for example, from PUR or PVC. The emulsion of the present disclosure can also be useful for bonding dissimilar materials together. In some of these embodiments, the first substrate comprises a metal, and the second substrate comprises a rubber or plastic. In some embodiments, the first and second substrates are dissimilar plastics. The emulsion of the present disclosure can also be useful for packaging in which either the first or second substrate is a cellulosic material such paper (e.g., polymer-coated paper), paperboard, hardwood, softwood, oriented strand board, plywood, cardboard, pressed fiber boards, wood veneer, particleboard, chipboard, and fiberboard. Wood substrates may be treated or untreated and may include birch, pine, oak, maple, mahogany, and cherry. Wood substrates may also comprise wood in combination with another material, such as wood/resin composites (e.g., phenolic composites), composites of wood fibers and thermoplastic polymers, and wood composites reinforced with cement, fibers, or plastic cladding.

### Some Embodiments of the Disclosure

In a first embodiment, the present disclosure provides an emulsion comprising: water; an emulsifier; and acrylic polymer particles dispersed in the water, wherein the acrylic polymer particles comprise monomer units of at least one alkyl acrylate, alkyl methacrylate, or combination thereof, wherein alkyl has at least eight carbon atoms; at least one percent by weight acid-functional monomer units, based on the total weight of the acrylic polymer particles; monomer units of a high T_{g} monomer comprising at least one of t-octyl acrylamide, t-butyl methacrylate, t-butyl acrylate, isobornyl acrylate, or isobornyl methacrylate; and a chain terminal group having at least four carbon atoms and attached to the polymer through a thioether group. In a second embodiment, an emulsion comprising: water; an emulsifier; and acrylic polymer particles dispersed in the water, wherein the acrylic polymer particles comprise monomer units of at least one alkyl acrylate, alkyl methacrylate, or combination thereof, wherein alkyl has at least eight carbon atoms; at least one percent by weight acid-functional monomer units, based on the total weight of the acrylic polymer particles; monomer units of a high T_{g} monomer comprising at least one of t-octyl acrylamide, t-butyl methacrylate, t-butyl acrylate, isobornyl acrylate, or isobornyl methacrylate; and a chain terminal group having at least four carbon atoms and attached to the polymer through a thioether group, wherein the emulsion provides an adhesive able to hold a pinch bond in a foam cube within one minute of spraying the emulsion. In a third embodiment, the present disclosure provides the emulsion of the first or second embodiment, wherein the acrylic polymer particles further comprise monomer units of at least one C₁-C₆ alkyl acrylate. In a fourth embodiment, the present disclosure provides the emulsion of the third embodiment, wherein the acrylic polymer particles further comprise methyl acrylate or butyl acrylate monomer units. In a fifth embodiment, the present disclosure provides the emulsion of any one of the first to fourth embodiments, wherein the chain terminal group is present in an amount from 0.01 to 0.1, 0.05 to 0.1, 0.02 to 0.075, 0.025 to 0.06, or 0.03 to 0.04 percent by weight, based on the total weight of acrylic polymer particles (that is, monomer units and chain terminal groups). In a sixth embodiment, the present disclosure provides the emulsion of any one of the first to fifth embodiments, wherein the acrylic polymer particles make up at least 99% of the polymers in the emulsion. In a seventh embodiment, the present disclosure provides the emulsion of any one of the first to sixth embodiments, wherein the acrylic polymer particles are crosslinked. In an eighth embodiment, the present disclosure provides the emulsion of any one of the first to seventh embodiments, wherein the emulsion has a gel content of at least 28 percent. In a ninth embodiment, the present disclosure provides the emulsion of any one of the first to eighth embodiments, wherein the acrylic polymer particles further comprise monomer units bearing at least one ketone or aldehyde functional group or at least one ketone functional group. In a tenth embodiment, the present disclosure provides the emulsion of the ninth embodiment, further comprising a polyhydrazide crosslinker. In an eleventh embodiment, the present disclosure provides the emulsion of any one of the first to tenth embodiments, wherein the acrylic polymer further comprises monomer units of an acrylate or methacrylate having more than one acrylate or methacrylate group. In a twelfth embodiment, the present disclosure provides the emulsion of any one of the first to eleventh embodiments, wherein the acid-functional monomer units comprise acrylic acid monomer units, methacrylic acid monomer units, or a combination of acrylic acid monomer units and methacrylic acid monomer units. In a thirteenth embodiment, the present disclosure provides the emulsion of any one of the first to twelfth embodiments, wherein the emulsion has a pH of not more than 7 or in a range from 3 to 7, 3 to 6, or 3 to 5.

In a fourteenth embodiment, the present disclosure provides the emulsion of any one of the first to thirteenth embodiments, further comprising a propellent. In a fifteenth embodiment, the present disclosure provides the emulsion of any one of the first to fourteenth embodiments, wherein the composition or the spray adhesive composition is substantially free of thermoplastic microspheres containing a blowing agent. In a sixteenth embodiment, the present disclosure provides the emulsion of any one of the first to fifteenth embodiments, packaged in a spray container. In a seventeenth embodiment, the present disclosure provides the emulsion of any one of the first to sixteenth embodiments, wherein alkyl has 8 to 20, 8 to 16, 8 to 12, 8 to 10, or 8 carbon atoms. In an eighteenth embodiment, the present disclosure provides the emulsion of any one of the first to seventeenth embodiments, wherein the acrylic polymer particles have a size in a range from 50 nanometers to 10 micrometers, from 50 nanometers to 5 micrometers, or from 200 nanometers to 500 nanometers. In a nineteenth embodiment, the present disclosure provides the emulsion of any one of the first to eighteenth embodiments, wherein the emulsion comprises less than 0.1 percent by weight of an organic solvent, based on the total weight of the acrylic polymer particles. In a twentieth embodiment, the present disclosure provides the emulsion of any one of the first to nineteenth embodiments, wherein the acrylic polymer particles are not core-shell polymer particles having different monomer units in the core and in the shell.

In a twenty-first embodiment, the present disclosure provides the emulsion of any one of the first to twentieth embodiments, wherein the acrylic polymer particles comprise a range from 40 to 90 percent by weight of the monomer units of at least one alkyl acrylate, alkyl methacrylate, or combination thereof, wherein alkyl has at least 8 carbon atoms; a range of 0 to 25 percent by weight of a C₁-C₆ alkyl acrylate; a range of 2 to 5 percent by weight of the acid-functional monomer units; a range of 3 to 15 percent by weight of t-octyl acrylamide; a range from 0 to 5 percent by weight of monomer units bearing at least one ketone or aldehyde functional group, and a range from 0.02 to 0.075 percent by weight of the chain terminal group, based on the total weight of the monomer units in the acrylic polymer particles. In some of these embodiments, the acrylic polymer particles include 1.6 to 2.5 percent by weight of the emulsifier, based on the total weight of the monomer units in the acrylic polymer particles.

In a twenty-second embodiment, the present disclosure provides the emulsion of any one of the first to twentieth embodiments, wherein the acrylic polymer particles comprise a range from 40 to 90 percent by weight of the monomer units of at least one alkyl acrylate, alkyl methacrylate, or combination thereof, wherein alkyl has at least 8 carbon atoms; a range of 0 to 25 percent by weight of a C₁-C₆ alkyl acrylate; a range of 2 to 5 percent by weight of the acid-functional monomer units; a range of 10 to 30 percent by weight of t-butyl methacrylate; a range from 0 to 5 percent by weight of monomer units bearing at least one ketone or aldehyde functional group, and a range from 0.02 to 0.075 percent by weight of the chain terminal group, based on the total weight of the monomer units in the acrylic polymer particles.

In a twenty-third embodiment, the present disclosure provides a process for making the emulsion of any one of the first to twenty-second embodiments, the process comprising: combining components comprising water; the emulsifier; at least one alkyl acrylate, alkyl methacrylate, or combination thereof, wherein alkyl has at least eight carbon atoms; at least one percent by weight acid-functional monomer, based on the total weight of monomers; a high T_{g} monomer comprising at least one of t-octyl acrylamide, t-butyl methacrylate, t-butyl acrylate, isobornyl acrylate, or isobornyl methacrylate; a chain transfer agent comprising a mercaptan group and at least four carbon atoms; and a polymerization initiator; and reacting the at least one alkyl acrylate, alkyl methacrylate, or combination thereof, the acid-functional monomer, the high T_{g} monomer, the chain transfer agent, and optionally the emulsifier to provide the emulsion. In a twenty-fourth embodiment, the present disclosure provides the process of the twenty-third embodiment, wherein reacting the at least one alkyl acrylate, alkyl methacrylate, or combination thereof, the acid-functional monomer, the high T_{g} monomer, the chain transfer agent, and optionally the emulsifier to provide the emulsion is carried out at a temperature of not more than 70° C. In a twenty-fifth embodiment, the present disclosure provides the process of the twenty-third or twenty-fourth embodiment, wherein the components further comprise an acrylate or methacrylate having more than one acrylate or methacrylate group, and wherein a ratio of the chain transfer agent to the acrylate or methacrylate having more than one acrylate or methacrylate group is at least 1:1. In a twenty-sixth embodiment, the present disclosure provides the process of the twenty-fifth embodiment, wherein the high T_{g} monomer is t-octyl acrylamide, and wherein a ratio of the chain transfer agent to the acrylate or methacrylate having more than one acrylate or methacrylate group is at least 4:1. In a twenty-seventh embodiment, the present disclosure provides the process of the twenty-fifth embodiment, wherein the high T_{g} monomer is t-butyl methacrylate, and wherein a ratio of the chain transfer agent to the acrylate or methacrylate having more than one acrylate or methacrylate group is not more than 2:1. In a twenty-eighth embodiment, the present disclosure provides the process of any one of the twenty-third to twenty-seventh embodiments, wherein the components further comprise a monomer bearing at least one ketone or aldehyde functional group, and wherein the process further comprises adding a polyhydrazide crosslinker to the emulsion of acrylic polymer particles. In a twenty-ninth embodiment, the present disclosure provides the process of any one of the twenty-third to twenty-eighth embodiments, wherein a pre-emulsion comprising less than five percent by weight of the at least one alkyl acrylate, alkyl methacrylate, or combination thereof, the acid-functional monomer, the high T_{g} monomer, and the chain transfer agent, based on the total weight of these components, is reacted to form a seed emulsion, followed by adding and reacting a remaining amount of the at least one alkyl acrylate, alkyl methacrylate, or combination thereof, the acid-functional monomer, the high T_{g} monomer, and the chain transfer agent. In a thirtieth embodiment, the present disclosure provides the process of any one of the twenty-fourth to twenty-ninth embodiments, wherein a pre-emulsion comprising at least one of the at least one alkyl acrylate, alkyl methacrylate, or combination thereof, the acid-functional monomer, the high T_{g} monomer, or the chain transfer agent is reacted to form a seed emulsion in the presence of at least 5% by weight emulsifier, based on the total weight of the emulsion, followed by adding and reacting a remaining amount of the at least one alkyl acrylate, alkyl methacrylate, or combination thereof, the acid-functional monomer, the high T_{g} monomer, and the chain transfer agent in the presence of less than 5% by weight emulsifier, based on the total weight of the emulsion. In a thirty-first embodiment, the present disclosure provides the process of any one of the twenty-third to thirtieth embodiments, wherein the particles have a size in a range from 50 nanometers to 10 micrometers, from 50 nanometers to 5 micrometers, from 100 nanometers to 300 nanometers, or from 50 nm to 150 nm. In a thirty-second embodiment, the present disclosure provides the process of any one of the twenty-third to thirty-first embodiments, further comprising adding base to a pH of not more than 7, in a range from 3 to 6, or in a range from 3 to 5.

In a thirty-third embodiment, the present disclosure provides a process for making a bonded article comprising a first substrate and a second substrate, the process comprising spraying the emulsion of any one of the first to twenty-second embodiments on at least one of the first substrate or the second substrate to form an adhesive; and adhering the first substrate and the second substrate together. In a thirty-fourth embodiment, the present disclosure provides the process of the thirty-third embodiment, wherein adhering the first substrate and the second substrate together is carried out within one minute after spraying. In a thirty-fifth embodiment, the present disclosure provides the process of the thirty-third or thirty-fourth embodiment, wherein the adhesive is tacky within one minute after spraying. In a thirty-sixth embodiment, the present disclosure provides the process of any one of the thirty-third to thirty-fifth embodiments, wherein at least one of the first substrate or the second substrate is a fabric or a foam.

In order that this disclosure can be more fully understood, the following examples are set forth. It should be understood that these examples are for illustrative purposes only and are not to be construed as limiting this disclosure in any manner.

### EXAMPLES

This disclosure is not limited to the above-described embodiments but is to be controlled by the limitations set forth in the following claims and any equivalents thereof. This disclosure may be suitably practiced in the absence of any element not specifically disclosed herein.

Unless otherwise noted, all parts, percentages, ratios, etc. in the Examples and the rest of the specification are by weight. Unless otherwise indicated, all other reagents were obtained, or are available from fine chemical vendors such as Sigma-Aldrich Company, St. Louis, Missouri, or may be synthesized by known methods. The following abbreviations are used in this section: min=minutes, s=second, h=hour, g=gram, kg=kilogram, lb=pound, ft=feet, centimeter=cm, ° C.=degrees Celsius, oz=ounce, KPa=Pascal, rpm=revolutions per minute, m³=meters cubed, in.=inches, mL=milliliters, L=liters, RH=relative humidity, and RT=room temperature (i.e., 22° C. to 23° C.).

TABLE 1
Materials

| Abbreviation | Description and Source |
|---|---|
| APS | Ammonium persulfate (NH₄)₂S₂O₈, obtained from VWR, Radnor, PA, or from BDH |
| | (VWR Analytical) |
| KPS | Potassium persulfate, obtained from Sigma-Aldrich |
| SMBS | Sodium metabisulfite Na₂S₂O₅, obtained from Esseco, Parsippany, NJ |
| FSU | Ferrous sulfate heptahydrate, 0.15% FeSO₄•7H₂O obtained from JT Baker, Radnor, PA |
| OAIB | Octyl acrylate isomer blend prepared as described in U.S. Pat. No. Pat. No. 9,102,774 (Clapper et |
| | al.) |
| BA | n-butyl acrylate, obtained from BASF, Ludwigshafen, Germany |
| TBMA | t-butyl methacrylate, from BASF |
| TOA | N-Tert Octylacrylamide, obtained under the trade designation “OAA” from Nouryon, |
| | Amsterdam, The Netherlands |
| AA | Acrylic acid, obtained from BASF |
| MAA | Methacrylic acid, obtained from Alfa Aesar, Haverhill, MA |
| DAAM | Diacetone acrylamide, from KH Neochem, Tokyo, Japan, TCI Tokyo, Japan, and Thermo |
| | Scientific |
| EHTL | Chain transfer agent, obtained under the trade designation “Evabopol 196D”, from Bruno |
| | Bock, Teaneck, NJ |
| HDDA | Hexanediol diacrylate cross-linker, obtained under the trade designation “HDODA”, from |
| | Sartomer, Exton, PA |
| KH1025 | Polymerizable surfactant, 25% solution in water, obtained under the trade designation |
| | “HITENOL KH1025”, from Dai Ichi Kogyo Seiyaku, Kyoto, Japan |
| ADH | Adipic acid dihydrazide, obtained from TCI |
| AAEM | Acetoacetoxy ethyl methacrylate, obtained from Sigma Aldrich, Saint Louis, MO and |
| | under the trade designation “AAEMA” from Arxada Chemical, Basel, Switzerland |
| IOTG | Iso-octyl thioglycolate, obtained under the trade designation “Evabopol 198”, from Evans |
| | Chemetics, Waterloo, NY |
| TP1651 | Reducer, obtained under the trade designation “Bruggolite TP1651”, from Bruggemann |
| | Chemical, U.S., Inc., Newtown Square, PA |
| DSP | Disodium phosphate (Na₂HPO₄), obtained from Sigma Aldrich |
| FES32 | FES32, an anionic surfactant, 30% active, obtained under the trade designation |
| | “DISPONIL FES32”, from BASF |
| TBUOOH | Tert-butyl hydroperoxide (70%), obtained from Sigma Aldrich and from Alfa Aesar |
| DDM | t-Dodecyl mercaptan, obtained from Sigma Aldrich |
| 2EHA | 2-Ethylhexyl acrylate, obtained from BASF |
| MA | Methyl acrylate, from Dow, Midland, Michigan |
| TO8 | Nonionic surfactant, obtained under the trade designation “LUTENSOL TO8”, from |
| | BASF |

### Test Methods

### Gel Content Percentage Test

Using a moisture balance, a glass pad was tared and approximately 0.9 g of latex was added. The material was dried and the solids was recorded. The glass pad was then wrapped in a metal screen and weighed. The sample was then placed in a 4-oz (120-mL) jar with 50 mL of ethyl acetate and shaken for 24 h. The mesh-wrapped sample was then removed and dried for 1 h at 105° C., then weighed. The mass difference was used to calculate the gel percentage. The test was run in duplicate.

### 90-Degree Foam Bond and Foam Bond Stability Evaluations

Samples of high load-bearing 4-inch (10.2-cm) polyurethane foam cubes obtained from Foam Fabricators of Minnesota, Maple Lake, MN under Part No. 261401-2—S/C 4×4×4 3850GY (45 ILD) were used as a substrate, and 1 in.×1 in.×4 in. (2.54 cm×2.54 cm×10.2 cm) strips were used as adherends. This foam has a density of 1.4 to 1.6 lbs/ft³ (22.4 to 25.6 kg/m³) (ASTM D-3574-17) and an indentation load deflection at 25% deflection of 54 to 66 lbs/50 square inches (per ASTM D-3574-17). The foam cube samples were placed flat, providing a top face of the cube having two pairs of parallel, opposing edges. The top face was sprayed with between 1 g and 1.5 g of an emulsion Example or Illustrative Example described below at room temperature. An air assisted spray system (obtained under the trade designation “3M Accuspray ONE Spray Gun System with Standard PPS” and/or “3M Accuspray Paint Spray System with PPS 2.0” from 3M Company, Lindstrom, Minnesota) was used to spray the top face. The emulsion was fed through the gun with a gravity feed cup on the back and disposable 1.8-mm plastic nozzles. After a period of open time (i.e., time between spraying and bond formation) at room temperature, one foam strip was applied to the adhesive coated foam block surface manually for a 5 to 10 seconds. The minimum open time needed for the foam strip to adhere to the foam block surface for 24 hours at room temperature after finger pressure force was removed is reported in the 90° foam Evaluation in Table 6, below, under “Time”.

The bond stability was then evaluated at various conditions: Condition A was 70° C. for 48 h; Condition B was 90° C. for 48 h, and Condition D was 85° C., 85% RH for 200 h. If there was no bond separation for the duration of the test condition, the result is described as “P” in Table 6, below. If the foam strip began to lift or separate from the foam cube during the evaluation, the result is described as “F” in Table 6, below. The Conditions A, B, and D were achieved by placing the samples in a standard laboratory oven set to the desired conditions.

### Pinch Bond and Pinch Bond Stability Evaluations

Samples of the high load bearing 4-inch (10.2-cm) polyurethane foam cubes obtained from Foam Fabricators of Minnesota under Part No. 261401-2—S/C 4×4×4 3850GY (45 ILD) were used for the high-density foam pinch bond evaluation. Samples of a lower load bearing 4-inch (10.2-cm) polyurethane foam cubes obtained from Foam Fabricators of Minnesota under Part No. 261401-1—S/C 4×4×4 2450GY (36 ILD) were used as a substrate for the low-density pinch bond evaluation. This foam has a density of 0.85 to 1.1 lbs/ft³ (13.6 to 17.6 kg/m³) (ASTM D-3574-17) and an indentation load deflection at 25% deflection of 22 to 32 lbs/50 square inches (per ASTM D-3574-17). The foam cube samples were placed flat, providing a top face of the cube having two pairs of parallel, opposing edges as shown in FIG. 1a. The top face was sprayed with from 1 g to 2 g of an emulsion Example or Illustrative Example described below at room temperature using the same air assisted spray system described above for the 90-Degree Foam Bond Evaluation. After a period of open time (i.e., time between spraying and pinch bond formation) at room temperature, the edge of a 6-in. (15.24-cm) tongue depressor was pushed into the center of the cube and one pair of opposing edges was then brought into aligned contact such that the center part of the top face was pushed inwards towards the center of the cube as shown in FIG. 1b. The coated surfaces above the tongue depressor were pinched together for a few seconds using hand pressure, working from one end of the cube to the other as shown in FIG. 1c. FIG. 1d shows the pinch bond holding after finger pressure force is removed. The minimum open time needed for the pinch bond to hold together for 24 hours at room temperature after finger pressure force was removed is reported in Pinch Bond Evaluations in Table 6, below, under “Time”. This was repeated until the bond held together after hand pressure was released.

Pinch bond stability was the evaluated by testing bond separation at various conditions. The bond separation was then evaluated at various conditions: Condition Aa was 70° C. for 24 h; Condition B was 90° C. for 48 h, Condition C was 65° C./80-90% RH for 24 to 200 h, and Condition D was 85° C., 85% RH for 200 h. If there was no bond separation for the duration of the test condition, the result is described as “P” in Table 6, below. If the pinch bond partially or completely opened, the result is described as “F” in Table 6, below. Under condition C, the time of failure of the pinch bond is noted in Table 6, below. The Conditions Aa, B, C, and D were achieved by placing the samples in a standard laboratory oven set to the desired conditions.

### Examples 1 to 6 and Illustrative Examples A to C

The components used to prepare Examples 1 to 6 (EX1 to EX6) and Illustrative Examples A to C (IEA to IEC) are provided in Table 2 in grams (g). Components N, O, and M (for EX3 to EX5) were mixed and added to a first 2-L glass reactor equipped with a pitch-blade (double, stacked, flat pitched blade agitator). Each stack has four blades. Two sets of four ˜2×3.5 cm blades are separated by a distance of ˜6 cm). Components G to L and M2, if present, were mixed together and added to the first 2-L glass reactor slowly with agitation, and the resulting pre-emulsion was stirred at 600 rpm for approximately 30 min while deoxygenating with nitrogen. In a second 2-L glass reactor (Ace glass 6423-20), component A was added and stirred at 130 rpm with a double pitch blade agitator while degassing with nitrogen, about 30 min. The second 2-L glass reactor was then warmed to 30° C. using two 250 W IR lights controlled by a J-KEM Apollo Two controller, and the pre-emulsion was added as component E. After mixing briefly (ca. 2 min), ingredients B-D were added sequentially. The mixture was allowed to mix at 130 rpm at 30° C. for 20 min, during which a mild exotherm was observed (up to 32° C.). After 20 min, the reaction was heated to 55° C. Once the reaction reached 55° C., the pre-emulsion as component F was fed over 4 hr. After approximately 1 hour of feeding, the agitation was increased to 150 rpm. Agitation was maintained on the pre-emulsion during the feed and was lowered as needed to ensure minimal foaming (from 600 RPM to 100 RPM by the end of the feed). After the emulsion feed was complete, the reaction was heated to 70° C., the agitation increased to 200 rpm, and the reaction was cured for 3 hr, after which the reaction was cooled to room temperature. For EX3 to EX6, charge P and Q were combined and shaken to dissolve. If needed, the mixture was heated gently with a heat gun until homogeneous. The mixture was then added to the 2 L glass reactor while mixing. The mixture was stirred for 10 minutes then filtered through cheesecloth. The pH of the emulsions of EX 1 to EX6 and IEA to IEC was about 3.8.

TABLE 2
Examples 1 - 6 (EX1 - EX6) and Illustrative Examples A to C (IEA to IEC)

| | | EX1 | EX2 | IEA | IEB | IEC | EX3 | EX4 | EX5 | EX6 |
|---|---|---|---|---|---|---|---|---|---|---|
| | Charge | | | | | | | | | |
| A | DI Water | 350 | 350 | 350.22 | 350.12 | 350.34 | 350.88 | 350 | 350 | 350 |
| B | APS | 1.3 | 1.4 | 1.40 | 1.40 | 1.34 | 1.41 | 1.41 | 1.41 | 1.4 |
| C | SMBS | 0.3 | 0.3 | 0.33 | 0.33 | 0.33 | 0.34 | 0.35 | 0.34 | 0.3 |
| D | FSU | 1.5 | 1.5 | 1.53 | 1.54 | 2.58 | 1.51 | 1.52 | 1.52 | 1.5 |
| E | Pre-emulsion | 16 | 16 | 16.60 | 17.78 | 17.05 | 15.68 | 16.19 | 16.34 | 16 |
| | (seed) | | | | | | | | | |
| F | Pre-emulsion | 781 | 782 | 783.28 | 781.27 | 781.92 | 791.67 | 791.15 | 793.84 | 794 |
| | (feed) | | | | | | | | | |
| | Pre-emulsion_{—} | | | | | | | | | |
| G | OAIB | 427 | 427 | 428.08 | 427.56 | 427.13 | 428.40 | 427.89 | 427.26 | 427 |
| H | BA | 45 | 45 | 45.38 | 45.66 | 45.85 | 45.71 | 45.49 | 45.92 | 45 |
| I | TOA | 61 | 60 | 60.42 | 60.63 | 60.80 | 60.80 | 60.79 | 60.75 | 61 |
| J | AA | 22 | 22 | 22.36 | 22.17 | 22.24 | 22.28 | 22.38 | 22.20 | 22 |
| K | EHTL^{a} | 0.2 | 0.2 | 0.23 | 0.12 | 0.06 | 2.28 | 2.26 | 2.23 | 2.2 |
| L | HDDA^{a} | 0 | 0.6 | 1.21 | 0.56 | 0.56 | 0.56 | 0.56 | 0.56 | 0.6 |
| M | DAAM | 0 | 0 | 0 | 0 | 0 | 2.81 | 5.57 | 8.37 | 0 |
| M2 | AAEM^{b} | 0 | 0 | 0 | 0 | 0 | 0 | 0 | 0 | 11 |
| N | KH1025 | 42 | 42 | 42.03 | 42.21 | 42.31 | 42.25 | 42.19 | 42.13 | 42 |
| O | Water | 200 | 200 | 200.18 | 200.14 | 200.03 | 202.26 | 200.22 | 200.77 | 200 |
| | Post-add | | | | | | | | | |
| P | ADH | 0 | 0 | 0 | 0 | 0 | 1.17 | 2.38 | 3.52 | 3.72 |
| Q | Water | 0 | 0 | 0 | 0 | 0 | 13.19 | 27.19 | 39.78 | 41 |

^{a}Added as a 10% solution in OAIB.
^{b}Obtained from Sigma-Aldrich.

Examples 1 to 6 and Illustrative Examples A to C were evaluated for gel content using the method provided above. The results are shown in Table 3, below.

TABLE 3
Gel Percentages for EX1 to EX6 and IEA to IEC

| EX1 | EX2 | IEA | IEB | IEC | EX3 | EX4 | EX5 | EX6^{a} |
|---|---|---|---|---|---|---|---|---|
| 25.39% | 26.62% | 25.30% | 33.57% | 62.46% | 68.15% | 86.26% | 91.78% | 93.03% |
| 27.68% | 30.76% | 25.29% | 28.60% | 65.71% | 66.73% | 87.02% | 91.60% | 90.72% |

^{a}Evaluation performed on a run in which the source of AAEM was Chempoint.

### Examples 7 to 15 and Illustrative Example D

The components used to prepare Examples 7 to 15 (EX7-EX15) and Illustrative Example D (IED) are provided in Table 4 in grams. First, a monomer mixture (A-H) was prepared using the listed ingredients. Then pre-emulsion (U-AA) was prepared using the listed surfactant, water, and part of the monomer by charging them into a nitrogen-purged mixing tank. After that, components for the seed (I-O) except initiators were charged into a glass reactor and purged with nitrogen at room temperature for about 30 min. For Examples 7 to 12, 14, and 15, the temperature was increased to about 45° C., and for Example 13, the temperature was increased to about 60° C., and the initiators for making seed (P mixed with Q followed by R or S mixed with T) were added sequentially for seed polymerization (˜20 min). The temperature was then increased to about 75° C., then pre-emulsion (U-AA) and initiator feed (AB in AC) were started at the same time. The initiator feeding was about 4 h; the pre-emulsion feeding was about 3.5 h. After the pre-emulsion feeding, the emulsion was cured at 75° C. for about 1 h, then cooled to about 60° C. Then chaser ingredients (0.79 g 70% t-BuOOH in 4.71 g water and 0.55 g T1651 in 4.95 g water) were fed into the reactor over 1 h or 30 min. The emulsion was then cooled to room temperature and filtered with cheese cloth.

For Examples 7 to 10 and 12 to 15, a 10% ADH aqueous solution was prepared. About 100 g of emulsion was put into a glass or plastic container, and 1.5 g of 10% ADH aqueous solution was slowly added to the emulsion while mixing with a pipette. For Example 14, after adding ADH, the emulsion pH was adjusted to about 4.5 to 5 by adding ammonia. The pH of the emulsions of EX 7 to EX13, EX15, and IED was about 3.5 to 4.

TABLE 4
Examples 7 to 15 (EX7 - EX15) and Illustrative Example D (IED). Amounts are in grams (g).

| | | EX7 | EX8 | EX9 | EX10 | EX11 | IED | EX12 | EX13 | EX14 | EX15 |
|---|---|---|---|---|---|---|---|---|---|---|---|
| A | OAIB | 280.50 | 280.50 | 280.50 | 280.50 | 280.50 | 280.50 | 280.50 | 280.50 | 280.50 | 280.50 |
| B | BA | 110.00 | 110.00 | 110.00 | 110.00 | 110.00 | 110.00 | 110.00 | 110.00 | 110.00 | 110.00 |
| C | AA | 22.00 | 22.00 | 22.00 | 22.00 | 22.00 | 22.00 | 22.00 | 22.00 | 11.00 | 22.00 |
| D | MAA | 0.00 | 0.00 | 0.00 | 0.00 | 0.00 | 0.00 | 0.00 | 0.00 | 11.00 | 0.00 |
| E | TBMA | 137.50 | 137.50 | 137.50 | 137.50 | 137.50 | 137.50 | 137.50 | 137.50 | 137.50 | 121.00 |
| F | TOA | 0 | 0 | 0 | 0 | 0 | 0 | 0 | 0 | 0 | 16.5 |
| G | t-DDM^{a} | 1.10 | 0.83 | 0.83 | 1.10 | 0.83 | 1.10 | 1.10 | 1.10 | 0.83 | 1.10 |
| H | HDDA^{a} | 1.10 | 0.83 | 0.83 | 1.10 | 0.83 | 0.55 | 0.55 | 0.69 | 0.83 | 0.83 |
| | Seed stage | | | | | | | | | | |
| I | DI Water | 317.47 | 317.47 | 317.47 | 317.47 | 317.47 | 317.47 | 317.47 | 317.47 | 317.47 | 317.47 |
| J | DPS | 0.83 | 0.83 | 0.83 | 0.83 | 0.83 | 0.83 | 0.83 | 0.83 | 0.83 | 0.83 |
| K | Monomer | 27.50 | 27.50 | 27.50 | 27.50 | 27.50 | 27.50 | 27.50 | 27.50 | 27.50 | 27.50 |
| | mixture | | | | | | | | | | |
| L | DAAM | 0 | 0 | 0 | 0 | 0 | 0 | 0 | 0 | 0.06 | 0 |
| M | FES32 | 4.58 | 4.58 | 4.58 | 4.58 | 4.58 | 4.58 | 4.58 | 2.20 | 4.58 | 4.58 |
| N | “KH1025” | 0 | 0 | 0 | 0 | 0 | 0 | 0 | 3.30 | 0 | 0 |
| O | TO8 | 1.38 | 1.38 | 1.38 | 1.38 | 1.38 | 1.38 | 1.38 | 0 | 1.38 | 1.38 |
| P | APS | 0.44 | 0.44 | 0.44 | 0.44 | 0.44 | 0.44 | 0.44 | 0.28 | 0.44 | 0.44 |
| Q | water | 14.23 | 14.23 | 14.23 | 14.23 | 14.23 | 14.23 | 14.23 | 8.89 | 14.23 | 14.23 |
| R | TP1651 | 0.08 | 0.08 | 0.08 | 0.08 | 0.08 | 0.08 | 0.08 | 0.00 | 0.08 | 0.08 |
| S | SMBS | 0.00 | 0.00 | 0.00 | 0.00 | 0.00 | 0.00 | 0.00 | 0.11 | 0.00 | 0.00 |
| T | water | 7.24 | 7.24 | 7.24 | 7.24 | 7.24 | 7.24 | 7.24 | 9.89 | 7.24 | 7.24 |
| | Pre- | | | | | | | | | | |
| | emulsion | | | | | | | | | | |
| | feeding | | | | | | | | | | |
| U | DI Water | 239.13 | 239.13 | 239.13 | 239.13 | 239.13 | 239.13 | 239.13 | 239.13 | 239.13 | 239.13 |
| V | Monomer | 522.50 | 522.50 | 522.50 | 522.50 | 522.50 | 522.50 | 522.50 | 522.50 | 522.50 | 522.50 |
| | mixture | | | | | | | | | | |
| W | DAAM | 11.00 | 11.00 | 0.00 | 5.78 | 11.00 | 11.00 | 11.00 | 11.00 | 11.00 | 11.00 |
| X | AAEM | 0.00 | 0.00 | 11.00 | 0.00 | 0.00 | 0.00 | 0.00 | 0.00 | 0.00 | 0.00 |
| Y | FES32 | 13.76 | 13.76 | 13.76 | 13.76 | 13.76 | 13.76 | 13.76 | 13.76 | 13.76 | 13.76 |
| Z | KH1025 | 0 | 0 | 0 | 0 | 0 | 0 | 0 | 20.90 | 0 | 0 |
| AA | TO8 | 1.36 | 1.36 | 1.36 | 1.36 | 1.36 | 1.36 | 1.36 | 0 | 1.36 | 1.36 |
| | Initiator | | | | | | | | | | |
| | feeding | | | | | | | | | | |
| AB | APS | 0.66 | 0.66 | 0.66 | 0.66 | 0.66 | 0.66 | 0.66 | 0.83 | 0.66 | 0.66 |
| AC | water | 32.34 | 32.34 | 32.34 | 32.34 | 32.34 | 32.34 | 32.34 | 24.18 | 32.34 | 32.34 |
| | ADH | yes | yes | yes | yes | 0 | 0 | yes | yes | yes | yes |

^{a}Added as a 20% solution in EHA

### Examples 16 and 17 (?EX16 and EX 17)

The components used to prepare Examples 16 and 17 are provided in Table 5 in grams. First, a monomer mixture (A-E) was prepared using the listed components. Then pre-emulsion (0-T) was prepared using the listed surfactant, water, and part of the monomer by charging them into a nitrogen-purged mixing tank. After that, 230.42 g deionized water, 0.59 g DSP, 19.79 of the A-E monomer mixture, 3.30 g FES32, and 9.91 g of T08 (diluted to 10 wt. % with water) were charged into a glass reactor and purged with nitrogen at room temperature for about 30 min. Then the temperature was increased to about 45° C., and the initiators for making the seed (0.32 g of KPS in 3.00 g water and 0.06 g T1651 in 1.00 g water) were added sequentially for seed polymerization (˜20 min). The temperature was then increased to about 75° C., and then pre-emulsion (0-T) and initiator feed (0.48 g KPS in 56.61 g water) were started at the same time. The initiator feeding was about 4 h; the pre-emulsion feeding (0-T) was about 3.5 h. After the pre-emulsion feeding, the emulsion was cured at 75° C. for about 1 h and then cooled to about 60° C. Then chaser ingredients (0.65 g 70% t-BuOOH in 3.89 g water and 0.38 g T1651 in 3.44 g water) were fed into the reactor over 1 h or 30 min. The emulsion was then cooled to room temperature and filtered through cheese cloth. The pH of the emulsions of EX 16 and EX17 was about 3.5 to 4.

TABLE 5
Examples 16 and 17 (EX16 to EX17)

| | | EX-16 | EX-17 |
|---|---|---|---|
| | | (g) | (g) |
| A | EHA | 189.96 | 194.31 |
| B | MA | 75.19 | 75.19 |
| C | AA | 11.87 | 11.83 |
| D | TBMA | 118.96 | 118.96 |
| E | IOTG | 0.20 | 0.20 |
| | Pre-emulsion feeding | (g) | (g) |
| O | DI Water | 172.82 | 172.82 |
| P | Monomer mixture | 375.96 | 379.92 |
| Q | AAEM | 7.92 | 0 |
| R | DAAM | 0 | 3.96 |
| S | FES32 | 9.89 | 9.89 |
| T | TO8 (10%) | 9.91 | 9.91 |

TABLE 6
Results for 90 Degree Foam Evaluation and Pinch Bond Evaluations, including
Stability Tests for EX1 to EX17 and Illustrative Examples IEA to IAD

| | 90° Foam Evaluation | | | | | Low Density Foam Pinch Bond | | | | | | High Density Foam Pinch Bond | | | | | |
|---|---|---|---|---|---|---|---|---|---|---|---|---|---|---|---|---|---|
| | | | Stability Condition | | | | | Stability Condition | | | | | Stability Condition | | | | |
| EX | Time | | A | B | D | Time | | Aa | C | | D | Time | Aa | Bb | C | | D |
| C^{a} | 1 | min | P | P | nt^{b} | 30 | s | P | nt | | nt | 20 s | P | nt | nt | | nt |
| EX1 | 10 | s | F | nt | nt | 30 | s | F | nt | | nt | nt | nt | nt | nt | | nt |
| EX2 | 10 | s | F | nt | F | 30 | s | F | nt | | nt | nt | nt | nt | nt | | nt |
| IEA | 1 | min | F | nt | nt | 5 | min | nt | nt | | nt | nt | nt | nt | nt | | nt |
| IEB | 10 | s | F | nt | nt | 5 | min | F | nt | | nt | nt | nt | nt | nt | | nt |
| IEC | 10 | s | F | nt | nt | 5 | min | nt | nt | | nt | nt | nt | nt | nt | | nt |
| EX3 | 10 | s | P | P | F | 30 | s | P | nt | | F | 45 s | F | nt | nt | | nt |
| EX4 | 10 | s | P | P | P | 30 | s | P | nt | | nt | 20 s | P | nt | F | | F |
| EX5 | 10 | s | P | P | P | 30 | s | P | nt | | P | 20 s | P | nt | <48 | h | F |
| EX6^{c} | 10 | s | P | P | P | 30 | s | P | nt | | P | 20 s | P | nt | 200 | h | nt |
| EX7 | 10 | s | P | P | nt | 30 | s | P | 200 | h | nt | 20 s | P | P | >24 h, <48 h | | nt |
| EX8 | 10 | s | nt | P | P | 30 | s | nt | 200 | h | nt | 20 s | nt | P | >48, <200h | | nt |
| EX9 | 10 | s | nt | P | P | 30 | s | nt | 200 | h | nt | 20 s | nt | P | >48, <200 h | | nt |
| EX10 | 10 | s | P | P | nt | 30 | s | P | 200 | h | nt | 20 s | P | P | <24 | h | nt |
| EX11 | nt | | nt | nt | nt | nt | | nt | nt | | nt | 20 s | nt | F | nt | | nt |
| EX12 | 10 | s | P | P | nt | 30 | s | P | >48, <200 h | | nt | 20 s | P | P | <24 | h | nt |
| IED | nt | | nt | nt | nt | nt | | nt | nt | | nt | F^{d} | nt | nt | nt | | nt |
| EX13 | 10 | s | P | P | P | 30 | s | P | >48 | h | nt | 20 s | P | P | nt | | nt |
| EX14 | nt | | nt | nt | nt | 30 | s | P | nt | | nt | 30 s | P | nt | nt | | nt |
| EX15 | 10 | s | P | P | nt | 30 | s | P | >200 | h | nt | 20 s | nt | P | <12 | h | nt |

| | | | | | | | | | | | | | | | |
|---|---|---|---|---|---|---|---|---|---|---|---|---|---|---|---|
| EX16 | 10 | s | P | P | P | 30 | s | P | nt | nt | 20 s | P | P | nt | nt |
| EX17 | 10 | s | P | nt | F | 30 | s | P | nt | nt | nt | nt | nt | nt | nt |

^{a}Aqueous Contact Adhesive, obtained under the trade designation “FASTBOND 100”, from 3M Company, St. Paul, MN.
^{b}nt = not tested.
^{c}Evaluation performed on a run in which the source of AAEM was Chempoint.
^{d}A pinch bond was made after 20 s of open time, but the bond separated before 24 hours at room temperature.

This disclosure is not limited to the above-described embodiments but is to be controlled by the limitations set forth in the following claims and any equivalents thereof.

1. An emulsion comprising:
water;
an emulsifier; and
acrylic polymer particles dispersed in the water, wherein the acrylic polymer particles comprise monomer units of an alkyl acrylate, alkyl methacrylate, or combination thereof, wherein alkyl has at least eight carbon atoms; at least one percent by weight acid-functional monomer units, based on the total weight of the acrylic polymer particles; monomer units of a high T_{g} monomer comprising at least one of t-octyl acrylamide, t-butyl methacrylate, t-butyl acrylate, isobornyl acrylate, or isobornyl methacrylate; and a chain terminal group having at least four carbon atoms and a thioether group,
wherein the emulsion provides an adhesive able to hold a pinch bond in a foam cube within one minute of spraying the emulsion.

2. The emulsion of claim 1, wherein the acrylic polymer particles further comprise monomer units of at least one C₁-C₆ alkyl acrylate.

3. The emulsion of claim 1, wherein the acrylic polymer particles make up at least 99% of the polymers in the emulsion.

4. The emulsion of claim 1, wherein the acrylic polymer particles are crosslinked.

5. The emulsion of claim 1, wherein the acrylic polymer particles further comprise monomer units bearing at least one ketone or aldehyde functional group.

6. The emulsion of claim 5, further comprising a polyhydrazide crosslinker.

7. The emulsion of claim 1, wherein the emulsion has a pH of not more than 7.

8. The emulsion of claim 1, wherein the emulsion comprises less than 0.1 percent by weight of an organic solvent, based on the total weight of the acrylic polymer particles.

9. The emulsion of claim 1, wherein the acid-functional monomer units comprise acrylic acid monomer units, methacrylic acid monomer units, or a combination of acrylic acid monomer units and methacrylic acid monomer units.

10. The emulsion of claim 1, wherein the acrylic polymer particles are not core-shell polymer particles having different monomer units in the core and in the shell.

11. The emulsion of claim 1, wherein the acrylic polymer particles comprise a range from 40 to 90 percent by weight of the monomer units of at least one alkyl acrylate, alkyl methacrylate, or combination thereof, wherein alkyl has at least 8 carbon atoms; a range of 0 to 25 percent by weight of a C₁-C₆ alkyl acrylate; a range of 2 to 5 percent by weight of the acid-functional monomer units; a range of 3 to 15 percent by weight of t-octyl acrylamide; a range from 0 to 5 percent by weight of monomer units bearing at least one ketone or aldehyde functional group, a range from 0.02 to 0.075 percent by weight of the chain terminal group, and a range 1.6 to 2.5 percent by weight of the emulsifier, based on the total weight of the monomer units of the acrylic polymer particles.

12. A process for making the emulsion of claim 1, the process comprising:
combining components comprising water, the emulsifier, the alkyl acrylate, alkyl methacrylate, or combination thereof, at least one percent by weight of the acid-functional monomer, based on the total weight of monomers, the high T_{g} monomer, a chain transfer agent comprising a mercaptan group, an a polymerization initiator; and
reacting the alkyl acrylate, alkyl methacrylate, or combination thereof; the acid-functional monomer, the high T_{g} monomer, the chain transfer agent, and optionally the emulsifier to provide the emulsion.

13. The process of claim 12, wherein the components further comprise an acrylate or methacrylate having more than one acrylate or methacrylate group, and wherein a ratio of the chain transfer agent to the acrylate or methacrylate having more than one acrylate or methacrylate group is at least 1:1.

14. The process of claim 12, wherein the components further comprise a monomer bearing at least one ketone or aldehyde functional group, and wherein the process further comprises adding a polyhydrazide crosslinker to the emulsion of acrylic polymer particles.

15. A process for making a bonded article comprising a first substrate and a second substrate, wherein at least one of the first substrate or the second substrate is a foam or a fabric, the process comprising:
spraying the emulsion of claim 1 on at least one of the first substrate or the second substrate to form an adhesive; and
adhering the first substrate and the second substrate together.

16. The emulsion of claim 7, wherein the emulsion has a pH in a range from 3 to 6.

17. The emulsion of claim 1, wherein the acrylic polymer further comprises monomer units of an acrylate or methacrylate having more than one acrylate or methacrylate group.

18. The emulsion of claim 1, wherein the emulsion has a gel content of at least 28 percent.

19. The emulsion of claim 1, wherein the chain terminal group is present in an amount from 0.01 to 0.1 percent by weight, based on the total weight of monomer units and chain terminal groups of the acrylic polymer particles.

20. The emulsion of claim 1, wherein the acrylic polymer particles further comprise methyl acrylate or butyl acrylate monomer units.
